(19) United States
(12) Patent Application Publication
(10) Pub. No.: US 2026/0231191 A1
(43) Pub. Date: Aug. 6, 2026

(54) SYSTEM INFORMATION BLOCK TYPE 1 DOWNLINK CHANNEL REPETITION USING A DEPLOYMENT CONFIGURATION

(71) Applicant: QUALCOMM Incorporated, San Diego, CA (US)

(72) Inventors: Jae Ho RYU, San Diego, CA (US); Xiao Feng WANG, San Diego, CA (US); Hobin KIM, San Diego, CA (US)

(21) Appl. No.: 19/462,149

(22) Filed: Jan. 28, 2026

Related U.S. Application Data
(60) Provisional application No. 63/753,071, filed on Feb. 3, 2025.

(51) Int. Cl. H04W 72/30; H04W 72/0446; H04W 72/231

(52) U.S. Cl. CPC H04W 72/30; H04W 72/0446; H04W 72/231

(57) ABSTRACT

Various aspects of the present disclosure generally relate to wireless communication. In some aspects, a user equipment (UE) may receive, using a particular deployment configuration, two consecutive slots that are assigned to a system information block type 1 (SIB1) of a non-terrestrial network. The UE may process at least one slot of the two consecutive slots using a downlink channel repetition configuration that has a linkage to the particular deployment configuration. Numerous other aspects are described.

### CROSS-REFERENCE TO RELATED APPLICATION

This Patent Application claims priority to U.S. Provisional Patent Application No. 63/753,071, filed on February 3, 2025, entitled “SYSTEM INFORMATION BLOCK TYPE 1 DOWNLINK CHANNEL REPETITION USING A DEPLOYMENT CONFIGURATION,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with system information block type 1 downlink channel repetition using a deployment configuration.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

An access procedure associated with a wireless network, such as an initial access procedure and/or an initial acquisition procedure, may enable a user equipment (UE) to establish a wireless link with a network node operating within the wireless network. As part of an initial access procedure, a network node may transmit one or more synchronization signals and a physical broadcast channel (PBCH) that provide a UE with enough information to obtain and decode a master information block (MIB). The MIB may indicate information that enables the UE to obtain and decode a system information block type 1 (SIB1). The SIB1 may include cell-specific information, such as any combination of a cell configuration, a public land mobile network (PLMN) identity, random access parameters, or scheduling information, that enables the UE to connect to the network node.

### SUMMARY

The systems, methods, and devices of this disclosure each have several innovative aspects, no single one of which is solely responsible for the desirable attributes disclosed herein.

Some aspects described herein relate to a method of wireless communication performed by a user equipment (UE). The method may include receiving, using a particular deployment configuration, two consecutive slots that are assigned to a system information block type 1 (SIB1) of a non-terrestrial network. The method may include processing at least one slot of the two consecutive slots using a downlink channel repetition configuration that has a linkage or an association to the particular deployment configuration.

Some aspects described herein relate to a method of wireless communication performed by a network node. The method may include transmitting, using a particular deployment configuration, two consecutive slots that are assigned to a SIB1 of a non-terrestrial network, the transmitting being based at least in part on a downlink channel repetition configuration that has a linkage or an association to the particular deployment configuration.

Some aspects described herein relate to a UE for wireless communication. The UE may include a processing system. The processing system may include one or more processors and one or more code-storing memories coupled with the one or more processors. The processing system may be configured to cause the UE to receive, using a particular deployment configuration, two consecutive slots that are assigned to a SIB1 of a non-terrestrial network. The processing system may be configured to cause the UE to process at least one slot of the two consecutive slots using a downlink channel repetition configuration that has a linkage or an association to the particular deployment configuration.

Some aspects described herein relate to a network node for wireless communication. The network node may include a processing system. The processing system may include one or more processors and one or more code-storing memories coupled with the one or more processors. The processing system may be configured to cause the network node to transmit, using a particular deployment configuration, two consecutive slots that are assigned to a SIB1 of a non-terrestrial network, the transmitting being based at least in part on a downlink channel repetition configuration that has a linkage or an association to the particular deployment configuration.

Some aspects described herein relate to a non-transitory computer-readable medium that stores a set of instructions for wireless communication by a UE. The set of instructions, when executed by one or more processors of the UE, may cause the UE to receive, using a particular deployment configuration, two consecutive slots that are assigned to a SIB1 of a non-terrestrial network. The set of instructions, when executed by one or more processors of the UE, may cause the UE to process at least one slot of the two consecutive slots using a downlink channel repetition configuration that has a linkage or an association to the particular deployment configuration.

Some aspects described herein relate to a non-transitory computer-readable medium that stores a set of instructions for wireless communication by a network node. The set of instructions, when executed by one or more processors of the network node, may cause the network node to transmit, using a particular deployment configuration, two consecutive slots that are assigned to a SIB1 of a non-terrestrial network, the transmitting being based at least in part on a downlink channel repetition configuration that has a linkage or an association to the particular deployment configuration.

Some aspects described herein relate to an apparatus for wireless communication. The apparatus may include means for receiving, using a particular deployment configuration, two consecutive slots that are assigned to a SIB1 of a non-terrestrial network. The apparatus may include means for processing at least one slot of the two consecutive slots using a downlink channel repetition configuration that has a linkage or an association to the particular deployment configuration.

Some aspects described herein relate to an apparatus for wireless communication. The apparatus may include means for transmitting, using a particular deployment configuration, two consecutive slots that are assigned to SIB1 of a non-terrestrial network, the transmitting being based at least in part on a downlink channel repetition configuration that has a linkage or an association to the particular deployment configuration.

Some aspects described herein relate to a UE. The UE may include a processing system. The processing system may include one or more processors and one or more code-storing memories coupled with the one or more processors. The processing system may be configured to cause the UE to receive PBCH signaling that indicates a downlink channel repetition configuration for a SIB1 PDCCH and PDSCH, the downlink channel repetition configuration comprising PDCCH content repetition and PDSCH content repetition in two consecutive slots that are assigned to a SIB1 related transmission. The processing system may be configured to cause the UE to receive the SIB1 related transmission in the two consecutive slots that are assigned to the SIB1 related transmission and include the PDCCH content repetition and the PDSCH content repetition. The processing system may be configured to cause the UE to process at least one slot of the two consecutive slots using the downlink channel repetition configuration.

Some aspects described herein relate to a network node. The network node may include a processing system. The processing system may include one or more processors and one or more code-storing memories coupled with the one or more processors. The processing system may be configured to cause the network node to transmit PBCH signaling that indicates a downlink channel repetition configuration for a SIB1 PDCCH and PDSCH, the downlink channel repetition configuration including PDCCH content repetition and PDSCH content repetition in two consecutive slots that are assigned to a SIB1 related transmission. The processing system may be configured to cause the network node to transmit the SIB1 related transmission in the two consecutive slots, the processing system configured to cause the network node to transmit the SIB1 related transmission based at least in part on the downlink channel repetition configuration.

Some aspects described herein relate to a method of wireless communication performed by a UE. The method may include receiving PBCH signaling that indicates a downlink channel repetition configuration for a SIB1 PDCCH and PDSCH, the downlink channel repetition configuration including PDCCH content repetition and PDSCH content repetition in two consecutive slots that are assigned to a SIB1 related transmission. The method may include receiving the SIB1 related transmission in two consecutive slots that are assigned to the SIB1 related transmission and include the PDCCH content repetition and the PDSCH content repetition. The method may include processing at least one slot of the two consecutive slots using the downlink channel repetition configuration.

Some aspects described herein relate to a method of wireless communication performed by a network node. The method may include transmitting PBCH signaling that indicates a downlink channel repetition configuration for a SIB1 PDCCH and PDSCH, the downlink channel repetition configuration including PDCCH content repetition and PDSCH content repetition in two consecutive slots that are assigned to a SIB1 related transmission. The method may include transmitting the SIB1 related transmission in the two consecutive based at least in part on the downlink channel repetition configuration.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings and appendix. Details of one or more implementations of the subject matter described in this disclosure are set forth in the accompanying drawings, the appendix, and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example disaggregated network node architecture.

FIG. 3 is a diagram illustrating an example of a regenerative satellite deployment and an example of a transparent satellite deployment in a non-terrestrial network.

FIG. 4 is a diagram illustrating an example of a system information block type 1 (SIB1) transmission.

FIG. 5 is a diagram illustrating an example of SIB1 physical downlink control channel (PDCCH) repetition and physical downlink shared channel (PDSCH) repetition transmission modes.

FIG. 6 is a diagram illustrating an example of mode4 transmission mode configurations that may be used for SIB1 PDCCH repetition and PDSCH repetition.

FIG. 7 is an example flow diagram of steps that may be included in a SIB1 processing procedure that may be performed by a user equipment (UE) for processing a SIB1 related transmission.

FIG. 8 is an example flow diagram of steps that may be included in a SIB1 processing procedure that may be performed by a UE for processing a SIB1 related transmission.

FIG. 9 is an example flow diagram of steps that may be included in a SIB1 processing procedure that may be performed by a UE for processing a SIB1 related transmission.

FIG. 10 is a diagram illustrating an example flow diagram of steps that may be included in a SIB1 processing procedure that may be performed by a UE for processing a SIB1 related transmission.

FIG. 11 is a diagram illustrating an example of a wireless communication process between a network node and a UE, in accordance with the present disclosure.

FIG. 12 is a diagram illustrating an example process performed, for example, at a UE or an apparatus of a UE.

FIG. 13 is a diagram illustrating an example process performed, for example, at a network node or an apparatus of a network node.

FIG. 14 is a diagram illustrating an example process performed, for example, at a UE or an apparatus of a UE.

FIG. 15 is a diagram illustrating an example process performed, for example, at a network node or an apparatus of a network node.

FIG. 16 is a diagram of an example apparatus for wireless communication.

FIG. 17 is a diagram of an example apparatus for wireless communication.

### DETAILED DESCRIPTION

An access procedure associated with a wireless network, such as an initial access procedure and/or an initial acquisition procedure, may enable a user equipment (UE) to establish a wireless link with a network node operating within the wireless network. As part of an initial access procedure, a network node may transmit one or more synchronization signals and a physical broadcast channel (PBCH) that provide a UE with enough information to obtain and decode a master information block (MIB). The MIB may indicate information that enables the UE to obtain and decode a system information block type 1 (SIB1). The SIB1 may include cell-specific information, such as any combination of a cell configuration, a public land mobile network (PLMN) identity, random access parameters, or scheduling information, that enables the UE to connect to the network node.

A network node may transmit the SIB1 on a periodic basis to ensure that UEs that enter, or power up, in a coverage area provided by the network node at different times each have access to the information provided by the SIB1 without delay. As an example, the network node may first transmit a SIB1 physical downlink control channel (PDCCH) that indicates scheduling information for a SIB1 physical downlink shared channel (PDSCH), and the SIB1 PDSCH may be PDSCH that carries the SIB1.

“SIB1 PDCCH repetition” denotes a SIB1 related transmission that includes repetitions of the SIB1 PDCCH (e.g., SIB1 PDCCH content repetition), and “SIB1 PDSCH repetition” denotes a SIB1 related transmission that includes repetitions of the SIB1 PDSCH (e.g., SIB1 PDSCH content repetition). The use of SIB1 PDCCH repetition, SIB1 PDSCH repetition, or a combination of the two, may enable a UE that supports the repetition(s) to recover from a decoding error by combining the repetitions to increase a likelihood of a successful SIB1 recovery. However, some communication standards do not support SIB1 PDCCH repetition, which may result in a delay in the UE successfully decoding the SIB1 PDCCH or may result in the UE failing entirely in decoding the SIB1 PDCCH. Alternatively, or additionally, for SIB1 PDSCH reception, a UE may have an expectation that the SIB1 PDSCH uses a default configuration or default format (e.g., an expectation that is specified by a communication standard), and the default configuration may lack flexibility to support evolving communication standards, such as a non-terrestrial network (NTN) communication standard, resulting in sub-optimal reception that may increase a delay in accessing the network. Conversely, a communication standard changing the default configuration or default format used for SIB1 reception may prevent older UEs that do not support the change from accessing the network.

Various aspects relate generally to SIB1 downlink channel repetition using a deployment configuration. Some aspects more specifically relate to a network node transmitting, and a UE receiving, a SIB1 PDCCH and a SIB1 PDSCH using a format or transmission mode that is linked to a particular deployment, where the format or transmission mode is backward compatible with a first UE that is a legacy UE as described below and forward compatible with a second UE that supports SIB1 PDCCH repetition (e.g.,SIB1 PDCCH content repetition), SIB1 PDSCH repetition (e.g., SIB1 PDSCH content repetition), or a combination of the two. In some aspects, a UE may receive two consecutive slots that are assigned to a SIB1 of an NTN using a particular deployment configuration, where the two consecutive slots may be dedicated to SIB1 related transmissions by a network node in the NTN. The UE may process at least one slot of the two consecutive slots using a downlink channel repetition configuration that has a linkage or an association to the particular deployment configuration. In some aspects, the linkage or the association may indicate whether SIB1 PDCCH repetition, SIB1 PDSCH repetition, or both, are supported in the particular deployment configuration. Alternatively, or additionally, the SIB1 related transmission may use, as the downlink channel repetition configuration, a transmission mode that is backward compatible with a first UE that does not support SIB1 PDCCH repetition and SIB1 PDSCH repetition, and provides repetition for a second UE that supports SIB1 PDCCH repetition and SIB1 PDSCH repetition.

Particular aspects of the subject matter described in this disclosure can be implemented to realize one or more of the following potential advantages. In some examples, by linking a downlink channel repetition configuration to a particular deployment configuration, the described techniques can be used to enable a UE that supports SIB1 PDCCH repetition and SIB1 PDSCH repetition to identify SIB1 related transmissions that include the repetitions and use the repetitions to increase a likelihood that the UE recovers SIB1 successfully. Recovering SIB1 successfully may reduce a latency in the UE accessing a network (e.g. an NTN) or may mitigate the UE failing to access the network. Alternatively, or additionally, the downlink channel repetition configuration may use a format that is backward compatible such that a UE that does not support SIB1 PDCCH repetition and SIB1 PDSCH repetition may successfully recover SIB1 and, subsequently, access the network.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

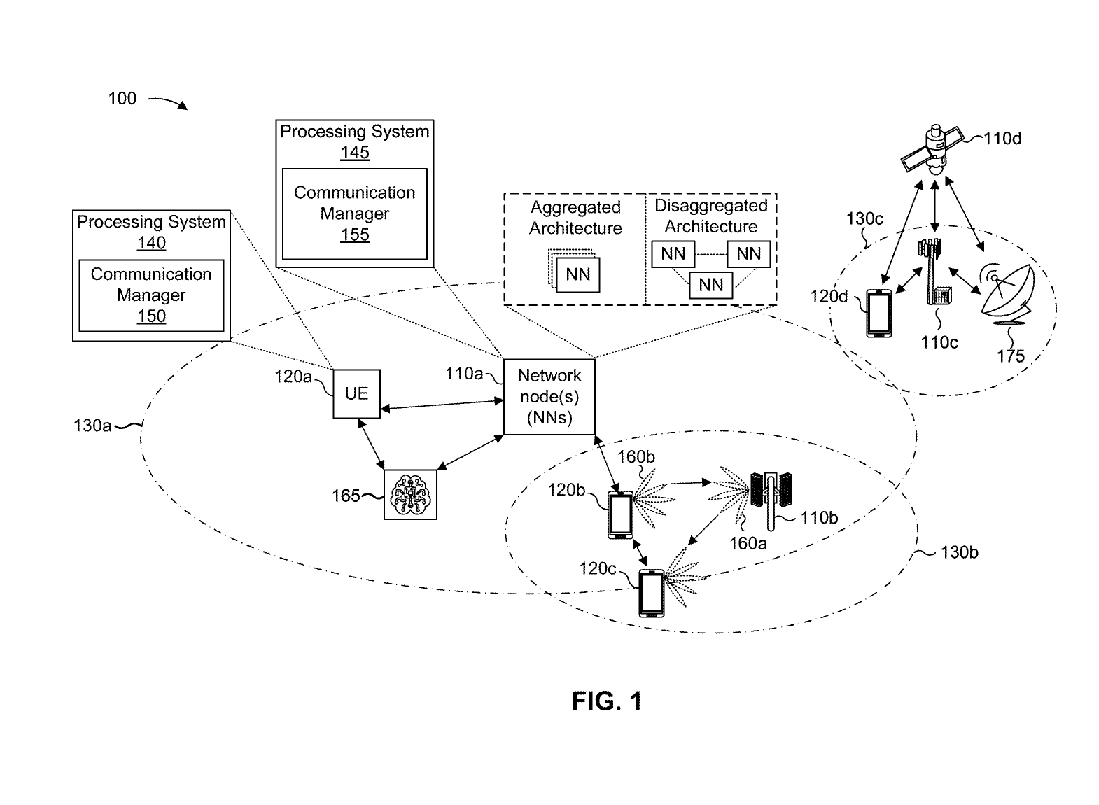

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a, a network node 110b, a network node 110c, and a network node 110d (each of which also may be referred to herein simply as a “network node 110”). The network nodes 110 may support communications with multiple UEs 120. For example, in FIG. 1, the network nodes 110 support communication with a UE 120a, a UE 120b, a UE 120c, and a UE 120d (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a, a cell 130b, and a cell 130c).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a PBCH), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)- reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collect measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

As indicated above, a network node 110 may be a terrestrial network node 110 (for example, a terrestrial base station or entity of a disaggregated base station) or an NTN network node 110. In the example shown in FIG. 1, the network node 110d may be an NTN node (for example, a network node 110 configured to operate in an NTN) and the cell 130c may be an NTN cell. For example, the wireless communication network 100 may include one or more NTN deployments including an NTN node or a relay station. In some examples, a relay station in an NTN deployment may be referred to as a “non-terrestrial relay station.” An NTN may facilitate access to the wireless communication network 100 for remote areas that may not otherwise be within a coverage area of a terrestrial network node 110, such as over water or remote areas in which a terrestrial network is not deployed. An NTN may provide connectivity for various applications, including satellite communications, IoT, MTC, or other applications. An NTN node may include a satellite, a manned aircraft system, or an unmanned aircraft system (UAS) platform, among other examples. A satellite may include a low-earth orbit (LEO) satellite, a medium-earth orbit (MEO) satellite, a geostationary earth orbit (GEO) satellite, or a high elliptical orbit (HEO) satellite, among other examples. A manned aircraft system may include an airplane, a helicopter, or a dirigible, among other examples. A UAS platform may include a high-altitude platform station (HAPS), a balloon, a dirigible, or an airplane, among other examples.

An NTN node may communicate directly or indirectly with other entities in the wireless communication network 100 using NTN communication. The other entities may include UEs 120 (e.g., a UE 120d), other NTN network nodes 110 in the one or more NTN deployments, other types of network nodes 110 (for example, stationary, terrestrial, or ground-based network nodes, such as the network node 110c), relay stations, or one or more components or devices included in or coupled with a core network of the wireless communication network 100. For example, an NTN node may communicate with a UE 120 via a service link (for example, where the service link includes an access link). Additionally or alternatively, an NTN node may communicate with a gateway 175 (for example, a terrestrial node providing connectivity for the NTN node to a data network or a core network) via a feeder link (for example, where the feeder link is associated with an N2 or an N3 interface). Additionally or alternatively, NTN nodes may communicate directly with one another via an inter-satellite link (ISL). In some examples, an NTN deployment may be transparent (for example, where the NTN node operates in a similar manner as a repeater or relay or where an access link does not terminate at the NTN node). In some other examples, an NTN deployment may be regenerative. For example, an access link may terminate at the NTN node, and the NTN node may regenerate a signal (such as by performing signal processing or enhancement, which may include error correction, modulation or demodulation, or amplification).

In some examples, NTNs may support advanced technologies or capabilities, such as global narrowband Internet of things (IoT) or massive machine type communication (mMTC) coverage (for example, NTNs may provide continuous coverage for narrowband IoT devices or mMTC devices to transfer data to a central entity), enhanced tracking (for example, NTNs may enable improved tracking for a moving platform (for example, a ship, a train, a plane, or a truck) carrying specific items to be tracked), emergency or disaster management, ultra mobile broadband (ultra-mBB) (for example, NTNs may enable a UE 120 to receive or transmit large amounts of data with improve quality of experience over a wider geographic area), immersive communications (for example, NTNs may support holographic communications, or extended reality (XR) communications, among other examples, to enable fully immersive user experiences), ultra-massive communications (for example, NTNs may enable tracking, monitoring, control, or environment sensing for IoT devices or mMTC devices, enabling applications, such as smart cities, smart agriculture, smart transportation, or smart logistics), ultra-critical communications (for example, NTNs may support services with increased requirements for latency, availability, or reliability; this enables applications, such as tactile or haptic Internet, remote surgery, or remote industrial management), network sensing (for example, NTNs may support RF sensing or an integrated sensing and communication (ISAC) service), or integrated artificial intelligence (AI) (for example, NTNs may support distributed or integrated AI applications), among other examples. In some examples, NTNs may provide connectivity for one or more verticals, such as aeronautical platforms, maritime platforms, railways, automotive platforms, rural areas, government platforms, or emergency services, among other examples.

An NTN may provide direct connectivity to the wireless communication network 100 for one or more UEs 120, such as the UE 120d. In some examples, a UE 120 may be configured to access the wireless communication network 100 via a terrestrial network (for example, the cell 130a) or an NTN (for example, the cell 130c) using common hardware or software (for example, using common radios or antennas). NTNs may provide ubiquitous connectivity for UEs 120 through compatibility with terrestrial networks (for example, NTNs and terrestrial networks may use compatible waveforms (for example, waveforms supported by both an NTN and a terrestrial network) for seamless handovers between NTNs and terrestrial networks, or UEs may use common hardware or software for communicating via NTNs and terrestrial networks), spectrum sharing (for example, a flexible waveform design may enable spectrum sharing between NTNs and terrestrial networks), robustness to co-channel interference, network-based positioning (for example, dedicated pilot signals or reference signals may be used to facilitate accurate timing and phase measurements for accurate positioning), support of UEs without location resolution data (for example, for UEs without access to a global navigation satellite system (GNSS)), or support of time division duplexing (TDD) and frequency division duplexing (FDD) systems, among other examples.

In some aspects, a UE (e.g., a UE 120) may include a communication manager 150. As described in more detail elsewhere herein, the communication manager 150 may receive, using a particular deployment configuration, two consecutive slots that are assigned to a SIB1 of a non-terrestrial network; and process at least one slot of the two consecutive slots using a downlink channel repetition configuration that has a linkage or an association to the particular deployment configuration. Additionally, or alternatively, the communication manager 150 may perform one or more other operations described herein.

In some aspects, a network node (e.g., a network node 110) may include a communication manager 155. As described in more detail elsewhere herein, the communication manager 155 may transmit, using a particular deployment configuration, two consecutive slots that are assigned to a SIB1 of a non-terrestrial network, the transmitting being based at least in part on a downlink channel repetition configuration that has a linkage or an association to the particular deployment configuration. Additionally, or alternatively, the communication manager 155 may perform one or more other operations described herein.

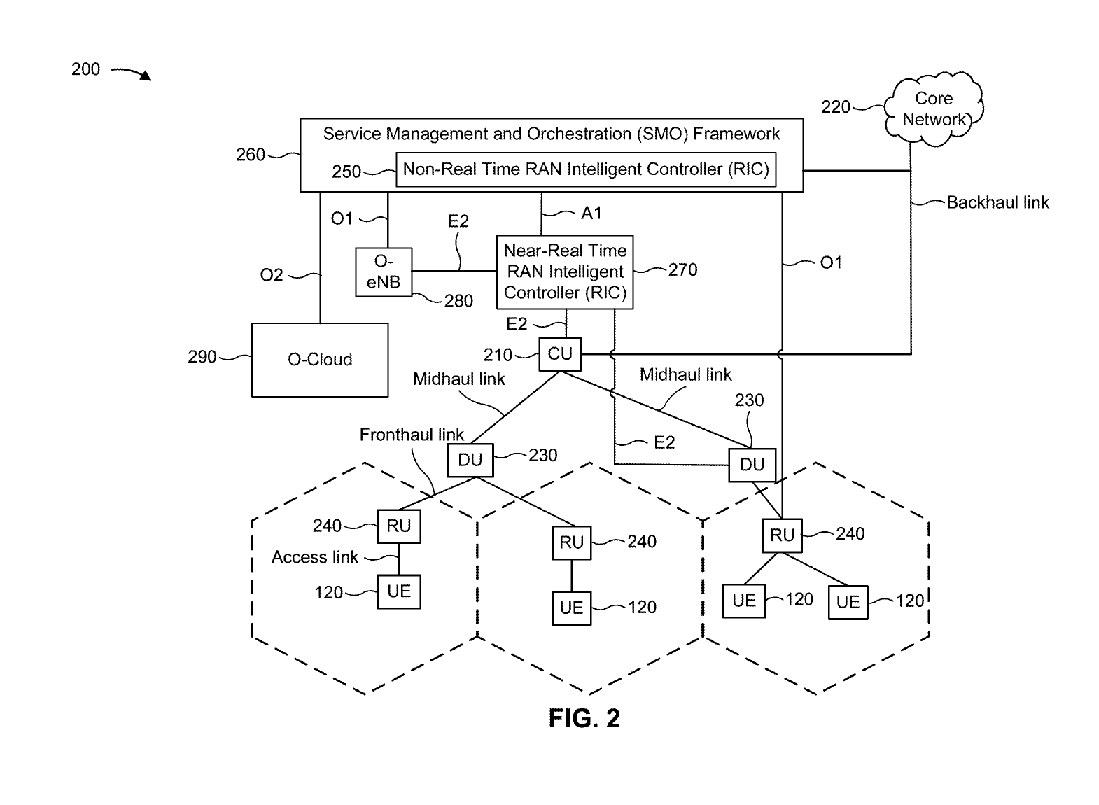

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally, or alternatively, the SMO Framework 260 may communicate directly with each of one or more RUs 240 via a respective O1 interface.

In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

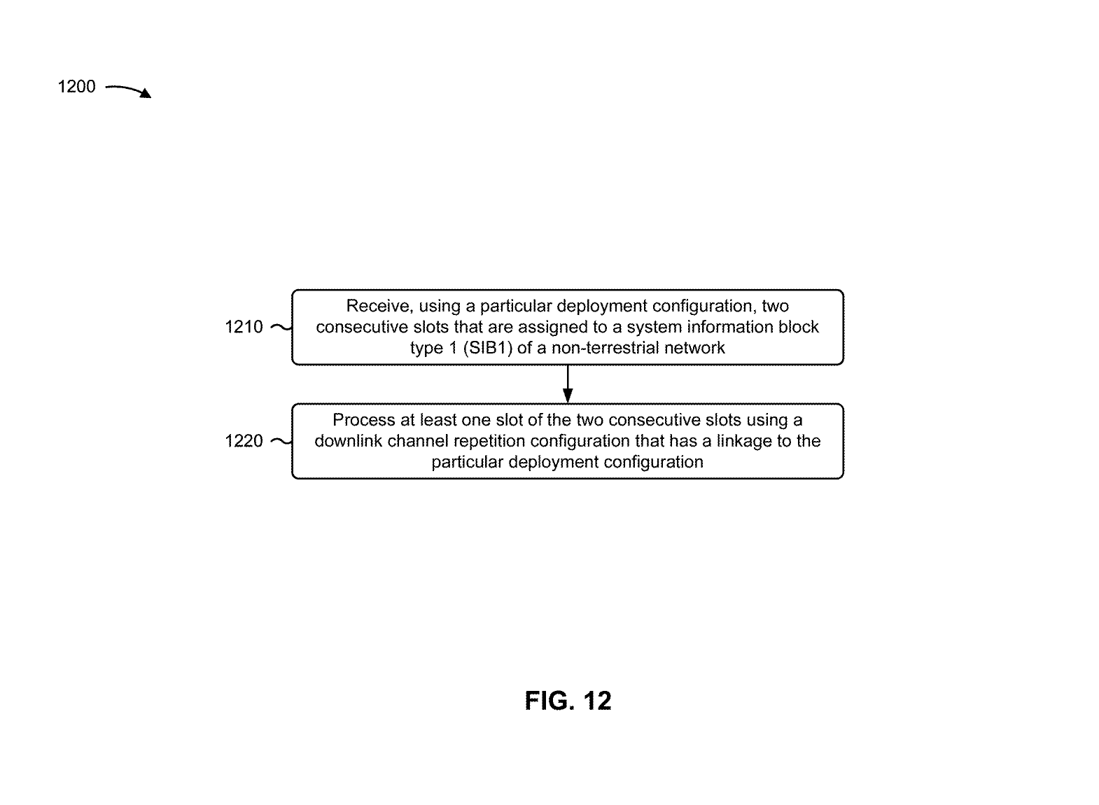

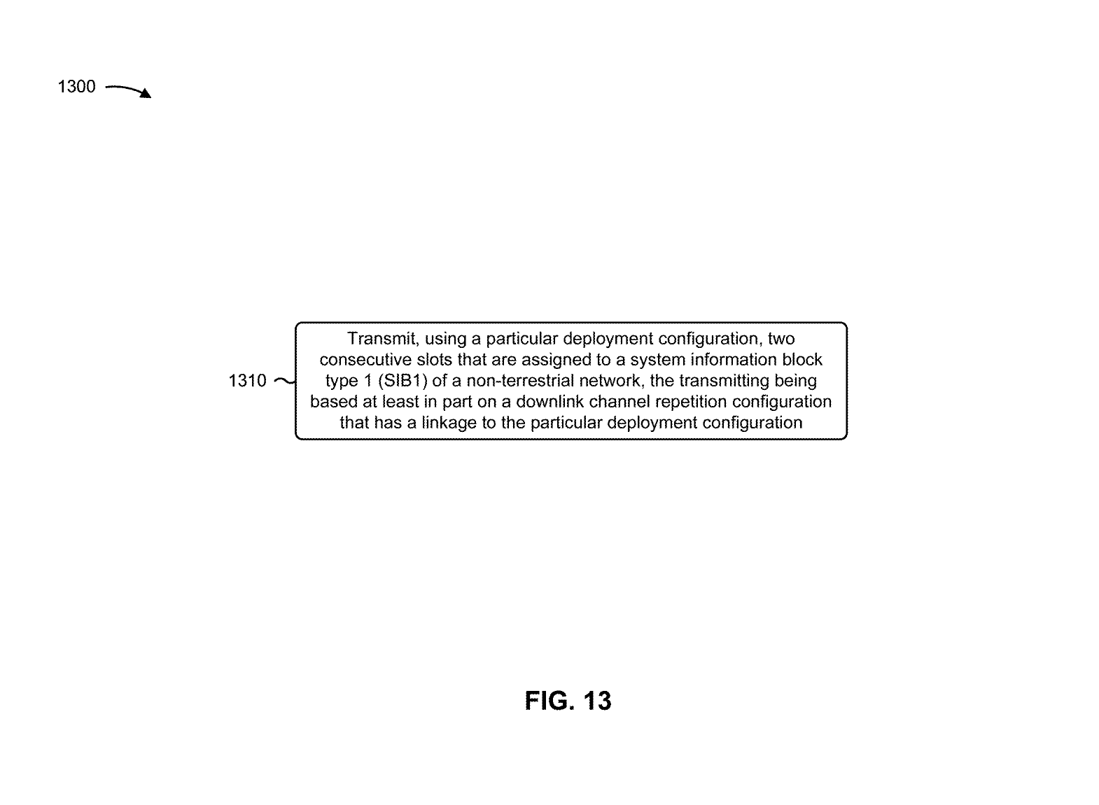

The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with SIB1 downlink channel repetition using a deployment configuration, as described in more detail elsewhere herein. For example, the processing system 145 of the network node 110, the processing system 140 of the UE 120, the CU 210, the DU 230, or the RU 240 may perform or direct operations of, for example, process 1200 of FIG. 12, process 1300 of FIG. 13, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 1200 of FIG. 12, process 1300 of FIG. 13, or other processes as described herein. In some examples, executing instructions may include running the instructions, converting the instructions, compiling the instructions, or interpreting the instructions, among other examples.

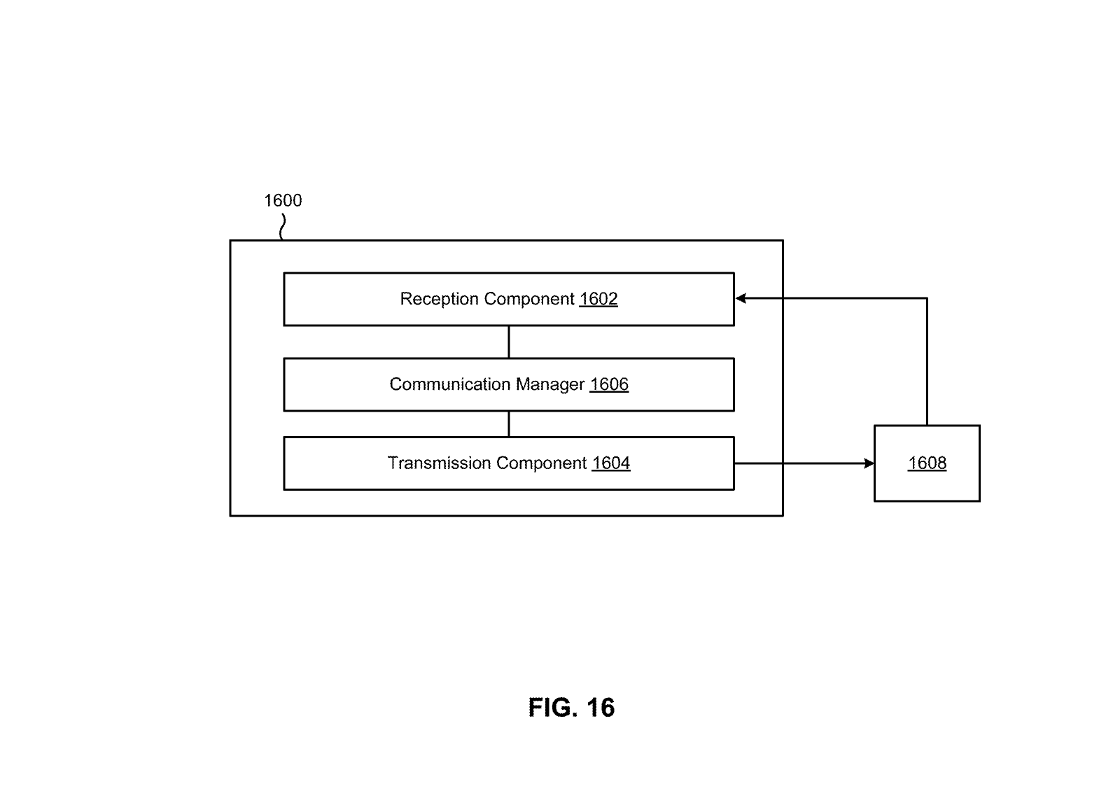

In some aspects, a UE (e.g., a UE 120) includes means for receiving, using a particular deployment configuration, two consecutive slots that are assigned to a SIB1 of a non-terrestrial network; and/or means for processing at least one slot of the two consecutive slots using a downlink channel repetition configuration that has a linkage or an association to the particular deployment configuration. The means for the UE to perform operations described herein may include, for example, one or more of communication manager 150, processing system 140, a radio, one or more RF chains, one or more transceivers, one or more antennas, one or more modems, a reception component (for example, reception component 1602 depicted and described in connection with FIG. 16), or a transmission component (for example, transmission component 1604 depicted and described in connection with FIG. 16), among other examples.

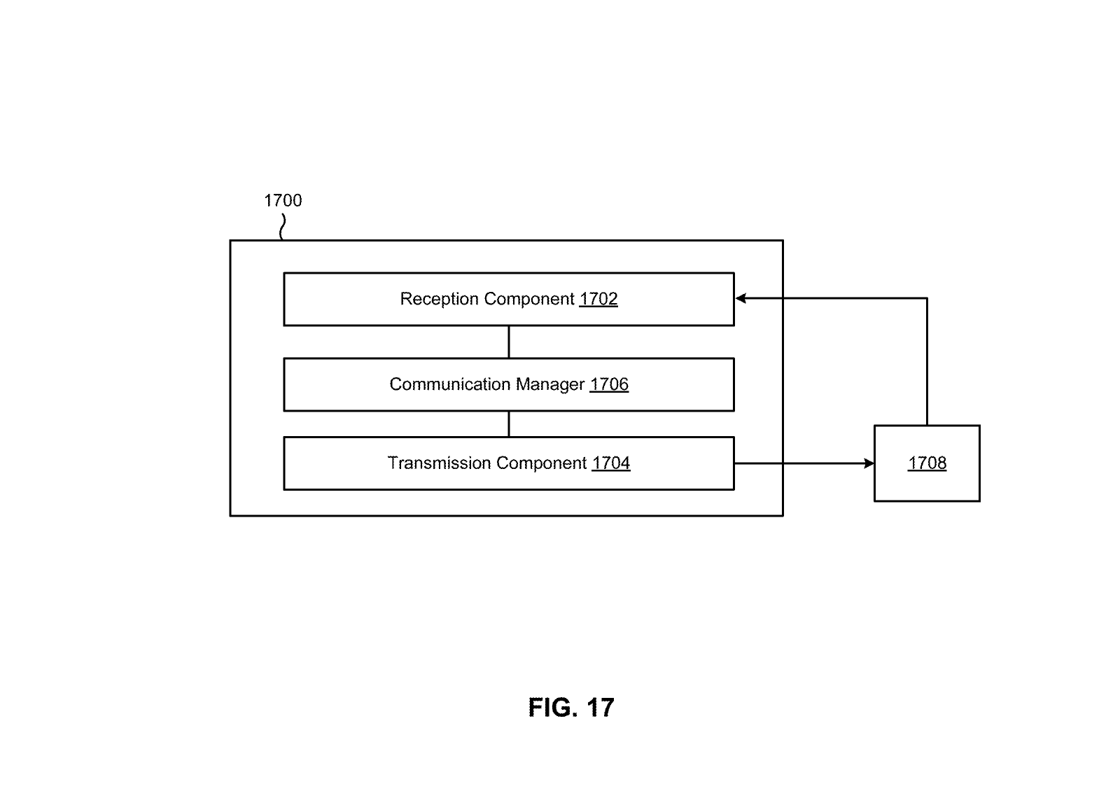

In some aspects, a network node (e.g., a network node 110) includes means for transmitting, using a particular deployment configuration, two consecutive slots that are assigned to a SIB1 of a non-terrestrial network, the transmitting being based at least in part on a downlink channel repetition configuration that has a linkage or an association to the particular deployment configuration. The means for the network node to perform operations described herein may include, for example, one or more of communication manager 155, processing system 145, a radio, one or more RF chains, one or more transceivers, one or more antennas, one or more modems, a reception component (for example, reception component 1702 depicted and described in connection with FIG. 17), or a transmission component (for example, transmission component 1704 depicted and described in connection with FIG. 17), among other examples.

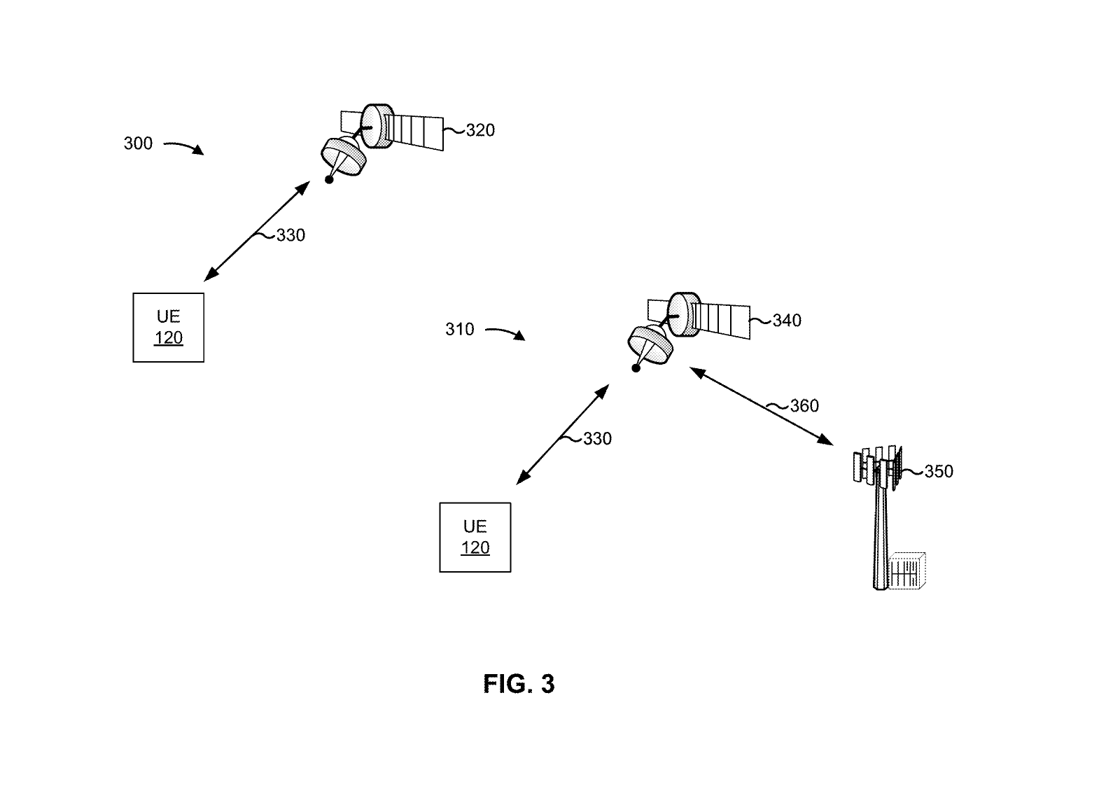

FIG. 3 is a diagram illustrating an example 300 of a regenerative satellite deployment and an example 310 of a transparent satellite deployment in a non-terrestrial network.

Example 300 shows a regenerative satellite deployment. In example 300, a UE 120 is served by a satellite 320 via a service link 330. For example, the satellite 320 may include a network node 110 (e.g., network node 110d) or a gNB. In some aspects, the satellite 320 may be referred to as a non-terrestrial base station, a regenerative repeater, or an on-board processing repeater. In some aspects, the satellite 320 may demodulate an uplink radio frequency signal, and may modulate a baseband signal derived from the uplink radio signal to produce a downlink radio frequency transmission. The satellite 320 may transmit the downlink radio frequency signal on the service link 330. The satellite 320 may provide a cell that covers the UE 120.

Example 310 shows a transparent satellite deployment, which may also be referred to as a bent-pipe satellite deployment. In example 310, a UE 120 is served by a satellite 340 via the service link 330. The satellite 340 may be a transparent satellite. The satellite 340 may relay a signal received from gateway 350 via a feeder link 360. For example, the satellite may receive an uplink radio frequency transmission, and may transmit a downlink radio frequency transmission without demodulating the uplink radio frequency transmission. In some aspects, the satellite may frequency convert the uplink radio frequency transmission received on the service link 330 to a frequency of the uplink radio frequency transmission on the feeder link 360, and may amplify or filter the uplink radio frequency transmission. In some aspects, the UEs 120 shown in example 300 and example 310 may be associated with a Global Navigation Satellite System (GNSS) capability or a Global Positioning System (GPS) capability, though not all UEs have such capabilities. The satellite 340 may provide a cell that covers the UE 120.

The service link 330 may include a link between the satellite 340 and the UE 120, and may include one or more of an uplink or a downlink. The feeder link 360 may include a link between the satellite 340 and the gateway 350, and may include one or more of an uplink (e.g., from the UE 120 to the gateway 350) or a downlink (e.g., from the gateway 350 to the UE 120). An uplink of the service link 330 may be indicated by reference number 330-U (not shown in FIG. 3) and a downlink of the service link 330 may be indicated by reference number 330-D (not shown in FIG. 3). Similarly, an uplink of the feeder link 360 may be indicated by reference number 360-U (not shown in FIG. 3) and a downlink of the feeder link 360 may be indicated by reference number 360-D (not shown in FIG. 3).

The feeder link 360 and the service link 330 may each experience Doppler effects due to the movement of the satellites 320 and 340, and potentially movement of a UE 120. These Doppler effects may be significantly larger than those in a terrestrial network. The Doppler effect on the feeder link 360 may be compensated for to some degree, but may still be associated with some amount of uncompensated frequency error. Furthermore, the gateway 350 may be associated with a residual frequency error, or the satellite 320/340 may be associated with an on-board frequency error. These sources of frequency error may cause a received downlink frequency at the UE 120 to drift from a target downlink frequency.

As indicated above, FIG. 3 is provided as an example. Other examples may differ from what is described with regard to FIG. 3.

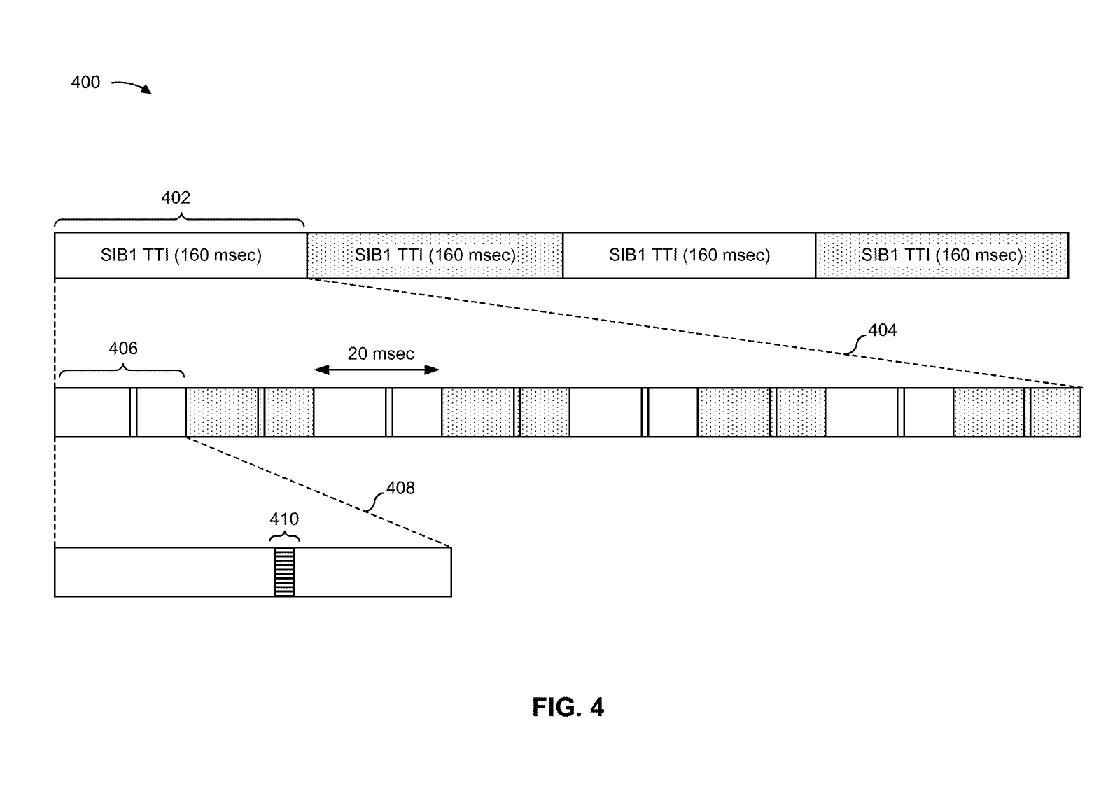

FIG. 4 is a diagram illustrating an example 400 of a SIB1 related transmission.

An access procedure associated with a wireless network, such as an initial access procedure and/or an initial acquisition procedure, may enable a UE (e.g., the UE 120) to establish a wireless link with a network node operating within the wireless network. As part of an initial access procedure, a network node may transmit one or more synchronization signals (e.g., PSS, SSS, or both) and a PBCH that provide a UE with enough information to obtain and decode an MIB. The MIB may indicate information that enables the UE to obtain and decode a SIB1, such as a pdcch-ConfigSIB1 parameter that indicates where in time-frequency resources (e.g., a core resource set (CORESET), a search space, or both) to search for a PDCCH that schedules the SIB1 in PDSCH. For example, the MIB may transmit configuration information for a type 0 common search space (type0-CSS) that is used by the UE to monitor for a PDCCH that indicates scheduling information of a SIB1. The SIB1 may include cell-specific information, such as any combination of a cell configuration, a PLMN identity, random access parameters, or scheduling information, that enables the UE to connect to the network node.

The network node may transmit the SIB1 on a periodic basis to ensure that UEs that enter, or power up, in a coverage area provided by the network node at different times each have access to the information provided by the SIB1 without delay. FIG. 4 illustrates a SIB1 related transmission time interval (TTI) 402 that may be periodically transmitted by a network node. Alternating SIB1 TTIs are shown by FIG. 4 using SIB1 TTIs in solid white that alternate with SIB1 TTIs with a dotted pattern. In the example 400, each SIB1 TTI spans 160 milliseconds (msec), but may vary from 160 msec in other examples. Each SIB1 TTI may include one or more SIB1 related transmissions.

To illustrate, a network node may transmit SIB1 with up to eight HARQ retransmissions within a SIB1 TTI. An expansion of the SIB1 TTI 402 is shown by reference number 404, and the expansion includes eight HARQ retransmission occasions that are associated with SIB1 recovery. A first HARQ retransmission occasion 406 is shown by FIG. 4 in solid white, and the subsequent HARQ retransmission occasions alternate between the solid white and a dotted pattern. Each HARQ retransmission occasion is shown by FIG. 4 as having a duration of 20 msec, but the duration may vary from 20 msec in other examples. An expansion of the HARQ retransmission occasion 406 is shown by reference number 408 and two consecutive slots 410 (shown with horizontal lines) that may be used for a SIB1 related transmission (e.g., two consecutive SIB1-related slots). The two consecutive slots 410 may be alternatively referred to as slot n0 and slot n0+1, where n0 is an index of the HARQ retransmission occasion within the SIB1 TTI. The slots within a HARQ retransmission occasion that are assigned to a SIB1 related transmission may be determined by the network node, and a UE may process the two consecutive slots 410 as monitoring occasions for a SIB1 related transmission.

Each slot of the two consecutive slots 410 may carry a combination of PDCCH and PDSCH. The PDCCH in a SIB1-related slot may include scheduling information for PDSCH in the SIB1-related slot, where the PDSCH carries the SIB1. Some wireless networks may support SIB1 PDSCH (e.g., PDSCH that carries SIB1) repetitions within a 20 msec occasion duration for a HARQ retransmission occasion that includes a single SIB1 related transmission as shown by FIG. 4 and, in some cases, the SIB1 PDSCH repetitions supported by the wireless networks may be a fixed number (e.g., 2). In a particular scenario, a wireless network in the form of an NTN, such as the NTN described with regard to FIG. 3, may support SIB1 PDCCH (e.g., PDCCH that indicates scheduling information for PDSCH that carries SIB1) repetitions.

Some communication standards may include specifications for PDCCH repetitions that are performed in two search space (SS) sets that are each associated with a respective CORESET, such as in a multiple transmit-receive point (mTRP) scenario in which multiple network nodes are distributed across different locations and simultaneously serve a UE. In some cases, the two SS sets are linked together via RRC signaling. Alternatively, or additionally, the linkage or the association between the two SS sets may be based at least in part on a condition that the two SS sets share one or more identical properties that may be RRC configured, such as any combination of a same SS set type, a monitored DCI format, a same quantity or number of candidates for each aggregation level (AL), a same CORESET duration, a same SS set periodicity, a same SS set slot offset, or a same number or quantity of monitoring occasions. Alternatively, or additionally, a communication standard may specify that two SS sets may not be linked together for any combination of SS set 0 (e.g., a predefined common search space mapped to CORESET 0), searchSpaceSIB1 and searchSpaceOtherSystemInformation (e.g., parameters that specify a predefined search space for SIB1 DCI), paging SearchSpace and ra-SearchSpace (e.g., parameters that specify a search space for paging-related DCI messages), or searchSpaceBroadcast, peiSearchSpace and sdt-SearchSpace (e.g. parameters that specify a search space for broadcast DCI, preemption indications, and decoding semi-persistent scheduling discontinuous transmission DCI, respectively).

To establish an initial connection with a network node, a UE may first receive and decode information carried by PBCH as described above, such as MIB. The UE may obtain CORESET0 and SearchSpace0 configuration information from the MIB that may then be used by the UE to obtain SIB1. In some cases, the initial connection does not support SIB1 PDCCH repetition, which may result in a delay in the UE successfully decoding the SIB1 PDCCH or may result in the UE failing entirely in decoding the SIB1 PDCCH. Alternatively, or additionally, for SIB1 PDSCH reception, a UE may have an expectation of a default configuration or default format used by the PDSCH to carry the SIB1 (e.g., an expectation as specified by a communication standard), that may lack flexibility to support evolving communication standards, resulting in sub-optimal reception that may increase a delay in accessing the network. Conversely, a communication standard changing the default configuration or default format used for SIB1 PDSCH reception may prevent older UEs that do not support the change from accessing the network, such as an NTN network.

Various aspects relate generally to SIB1 downlink channel repetition using a deployment configuration. Some aspects more specifically relate to a network node transmitting, and a UE receiving, SIB1 PDCCH and SIB1 PDSCH using a format or transmission mode that is linked to a particular deployment, where the format or transmission mode is backward compatible with a first UE that is a legacy UE as described below and forward compatible with a second UE that supports SIB1 PDCCH repetition, SIB1 PDSCH repetition, or a combination of the two. In some aspects, a UE may receive two consecutive slots that are assigned to a SIB1 of an NTN using a particular deployment configuration, where the two consecutive slots may be dedicated to SIB1 related transmissions by a network node in the NTN. The UE may process at least one slot of the two consecutive slots using a downlink channel repetition configuration that has a linkage or an association to the particular deployment configuration. In some aspects, the linkage or the association may indicate whether SIB1 PDCCH repetition, SIB1 PDSCH repetition, or both, are supported in the particular deployment configuration. Alternatively, or additionally, the SIB1 related transmission may use, as the downlink channel repetition configuration, a transmission mode that is backward compatible with a first UE that does not support SIB1 PDCCH repetition and SIB1 PDSCH repetition, and provides repetition for a second UE that supports SIB1 PDCCH repetition and SIB1 PDSCH repetition.

Particular aspects of the subject matter described in this disclosure can be implemented to realize one or more of the following potential advantages. In some examples, by linking a downlink channel repetition configuration to a particular deployment configuration, the described techniques can be used to enable a UE that supports SIB1 PDCCH repetition (e.g. SIB1 PDCCH content repetition) and SIB1 PDSCH repetition (e.g., SIB1 PDSCH content repetition) to identify SIB1 related transmissions that include the repetitions and use the repetitions to increase a likelihood that the UE recovers SIB1 successfully. Recovering SIB1 successfully may reduce a latency in the UE accessing a network (e.g. an NTN) or may mitigate the UE failing to access the network. Alternatively, or additionally, the downlink channel repetition configuration may use a format that is backward compatible such that a UE that does not support SIB1 PDCCH repetition and SIB1 PDSCH repetition may successfully recover SIB1 and, subsequently, access the network.

As indicated above, FIG. 4 is provided as an example. Other examples may differ from what is described with regard to FIG. 4.

Successful SIB1 recovery enables a UE to connect to a network node and gain access to services that are provided by the network node. Repeating SIB1 PDCCH (e.g., PDCCH repetition) or repeating SIB1 PDSCH (e.g., PDSCH repetition) may increase a likelihood that a UE supports repetitions to recover SIB1 successfully by combining the repetitions and decoding the combined repetitions. As one example, an NTN network node may support SIB1 PDCCH repetition and PDSCH repetition in which PDCCH repetitions and PDSCH repetitions may be transmitted in both slots of two consecutive slots that are allocated to SIB1 related transmissions (e.g., the two consecutive slots 410).

Some UEs connecting to the NTN network node may include support for SIB1 PDCCH repetition and PDSCH repetition, while others may not. To illustrate, a first UE connecting to the NTN may not include support for SIB1 PDCCH repetition and PDSCH repetition (e.g., a legacy UE), and a second UE connecting to the same NTN may include support for SIB1 PDCCH repetition and PDSCH repetition. Accordingly, the NTN may transmit SIB1 using a transmission mode configuration for the SIB1 PDCCH repetition and PDSCH repetition that is backward compatible with the first UE and increases the likelihood of a successful recovery by the second UE that supports PDCCH repetition and PDSCH repetition. That is, both a legacy UE and a UE that supports SIB1 PDCCH repetition and PDSCH repetition may successfully recover SIB1 from a same transmission based at least in part on the network node using a transmission mode configuration that may be understood by both UEs. Example transmission mode configurations are described below.

The transmission mode configuration used by a network node to transmit SIB1 may be based at least in part on a particular deployment configuration that is used for the SIB1 related transmission. To illustrate, a deployment configuration may be characterized based at least in part on a frequency band that is specified by a communication standard or a regulating body (e.g., the Federal Communications Commission (FCC), the European Telecommunications Standards Institute (ETSI), the International Telecommunication Union (ITU), 3GPP, the Ministry of Industry and Information Technology (MIIT), and/or the Telecom Regulatory Authority of India (TRAI)), and a communication standard may link the frequency band to SIB1 PDCCH repetition and PDSCH repetition. For instance, a first deployment configuration that operates in a first frequency band may be linked to SIB1 PDCCH repetition and PDSCH repetition such that a UE that uses the first frequency band to access a network node may have an expectation that the network node transmits the SIB1 using SIB1 PDCCH repetition and PDSCH repetition. A second deployment configuration that operates in a second frequency band may not be linked to SIB1 PDCCH repetition and PDSCH repetition such that a UE that uses the second frequency band to access the network node may have an expectation that the network node does not use SIB1 PDCCH repetition and PDSCH repetition to transmit SIB1.

A linkage or an association between a deployment configuration and a SIB1 PDCCH repetition and PDSCH repetition state (e.g., enabled or disabled) may be specified by a communication standard such that a UE implementing the communication standard may have implicit expectations. That is, the UE may determine whether a network node will use SIB1 PDCCH repetition and PDSCH repetition or not to transmit SIB1 based at least in part on a deployment configuration used by the UE and without explicit signaling that indicates the SIB1 PDCCH repetition and PDSCH repetition state. For instance, the UE may determine the SIB1 PDCCH repetition and PDSCH repetition state based at least in part on a frequency band that the UE uses in an initial access procedure as described above and without a network node transmitting explicit signaling that indicates the SIB1 PDCCH repetition and PDSCH repetition state. An example of explicit signaling by the network node may include a flag in PBCH that has a dedicated purpose to indicate the SIB1 PDCCH repetition and PDSCH repetition state.

As described above, a communication standard may specify a linkage or an association between a particular deployment configuration and a SIB1 PDCCH repetition and PDSCH repetition state, such as by specifying a linkage or an association between a frequency band and a SIB1 PDCCH repetition and PDSCH repetition state. In some aspects, the communication standard may specify the linkage or the association to a particular deployment configuration as at least part of specifying a synchronization raster. To illustrate, a synchronization raster may specify one or more carrier frequencies, and the communication standard may link one or more carrier frequencies in a synchronization raster to a respective SIB1 PDCCH repetition and PDSCH repetition state. As an example, the communication standard may specify a synchronization raster that includes one or more NTN frequency bands, and may specify a linkage between an NTN frequency band (or one or more carrier frequencies of the NTN frequency band) and a SIB1 PDCCH repetition and PDSCH repetition state for the NTN frequency band or a carrier frequency in the NTN frequency band. Accordingly, a UE may have an expectation that SIB1 PDCCH repetition and PDSCH repetition is available and present (or not available and not present) based at least in part on using a carrier frequency in a synchronization raster that is linked to an enabled SIB1 PDCCH repetition and PDSCH repetition state as specified by the communication standard.

In some aspects, a UE may determine a SIB1 PDCCH repetition and PDSCH repetition state based at least in part on a physical cell identifier (PCI) that the UE derives from a PSS or an SSS. For instance, a network operator or a communication standard may specify a linkage between a SIB1 PDCCH repetition and PDSCH repetition state and a PCI (or a subset of PCIs) that may be received in an NTN operating band. Accordingly, based at least in part on obtaining a PCI that is linked to an enabled SIB1 PDCCH repetition and PDSCH repetition state, a UE may have an expectation that a network node transmits a SIB1 using SIB1 PDCCH repetition and PDSCH repetition and/or a supported transmission mode. Based at least in part on obtaining a PCI that is not linked to an enabled SIB1 PDCCH repetition and PDSCH repetition state, the UE may have an expectation that a network node does not transmit a SIB1 using SIB1 PDCCH repetition and PDSCH repetition.

In the above examples, a UE may derive a SIB1 PDCCH repetition and PDSCH repetition state without explicit signaling from a network node that indicates the SIB1 PDCCH repetition and PDSCH repetition state. However, in other examples, a network node may transmit an explicit indication of the SIB1 PDCCH repetition and PDSCH repetition state. For instance, the network node may reuse a reserved bit in PBCH to indicate that SIB1 PDCCH repetition and PDSCH repetition is enabled or disabled, or PBCH may carry an explicit field that is dedicated to indicating the SIB1 PDCCH repetition and PDSCH repetition state.

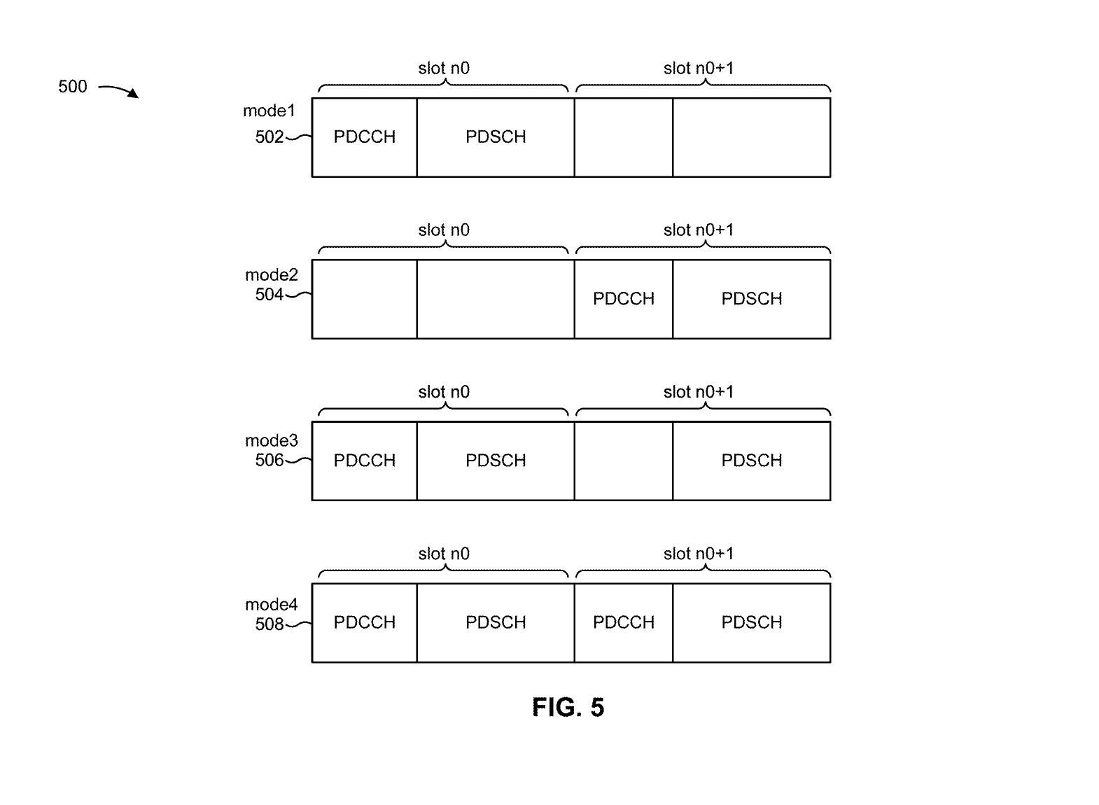

FIG. 5 is a diagram illustrating an example 500 of SIB1 PDCCH and PDSCH repetition transmission modes. “SIB1 PDCCH repetition and PDSCH repetition transmission mode” denotes a transmission mode or format for at least a combination of a PDCCH and a PDSCH, a PDCCH and PDSCH repetitions, or PDCCH repetitions and PDSCH repetitions that are used for transmitting a SIB1 related transmission. In some aspects, a SIB1 PDCCH repetition and PDSCH repetition transmission mode formats the repetitions in a manner that maintains backward compatibility such that a first UE (e.g., a legacy UE) and a second UE (e.g., that includes support for SIB1 PDCCH repetition and PDSCH repetition) may each obtain SIB1 information from a same SIB1 related transmission, where the second UE may use the repetitions to increase the likelihood of a successful SIB1 recovery. For example, the second UE may use PDCCH combining, PDSCH combining, or a combination of the two, as described below. The phrase “SIB1 PDCCH repetition and PDSCH repetition” may alternatively be referred to as “SIB1 PDCCH and PDSCH repetition.”

The SIB1 PDCCH and PDSCH repetition transmission modes shown by FIG. 5 may be used to transmit SIB1 PDCCH and SIB1 PDSCH in two consecutive slots of a HARQ retransmission occasion (e.g., the HARQ retransmission occasion 406 described with regard to FIG. 4). Each SIB1 PDCCH and PDSCH repetition transmission mode in the example 500 includes a configuration for slot n0 and slot n0+1 of the two consecutive slots in a manner that enables both the first UE and the second UE to successfully recover SIB1 from the SIB1 related transmission using a non-repetition-based procedure (e.g., by the first UE or the second UE) or combining (e.g., by the second UE).

A first SIB1 PDCCH and PDSCH repetition transmission mode 502, which may also be referred to as a mode1 transmission mode, does not include PDCCH repetition (e.g., PDCCH content repetition) and does not include PDSCH repetition (e.g., PDSCH content repetition). In slot n0 of the mode1 transmission mode, PDCCH and PDSCH are transmitted, and PDCCH and PDSCH are not transmitted in slot n0+1. In some aspects, slot n0+1 may be empty, and in other aspects, a network node may use slot n0+1 for another purpose (e.g., a unicast PDCCH or a unicast PDSCH). To recover SIB1 from a transmission that uses the first SIB1 PDCCH repetition and PDSCH repetition transmission mode, the first UE (e.g., the legacy UE) may monitor for PDCCH in slot n0 and, based at least in part on detecting PDCCH in slot n0, may decode PDSCH via a non-repetition-based procedure (e.g., a procedure that does not use PDCCH repetition, a procedure that does not use PDSCH repetition, a procedure that does not perform PDCCH combining as described below, or a procedure that does not perform PDSCH combining as described below). Decoding the PDSCH may be conditional on the first UE detecting that DCI carried by the PDCCH in slot n0 includes a cyclic redundancy check (CRC) that is scrambled with a system information radio network temporary identifier (SI-RNTI). The first UE may not monitor slot n0+1 based at least in part on successful detection and decoding of the PDCCH and the PDSCH in slot n0. The second UE may also monitor and detect PDCCH and PDSCH in slot n0 using the non-repetition-based procedure. In some aspects, the mode1 transmission mode may be backward compatible based at least in part on the first UE (e.g., a legacy UE) and the second UE being able to detect and decode PDCCH and PDSCH that is transmitted using the non-repetition-based procedure.

A second SIB1 PDCCH and PDSCH repetition transmission mode 504, which may also be referred to as a mode2 transmission mode, does not include PDCCH repetition and does not include PDSCH repetition. To illustrate, in slot n0+1 of the mode2 transmission mode, PDCCH and PDSCH are transmitted, and PDCCH and PDSCH are not transmitted in slot n0. The mode2 transmission mode may be complementary to the mode1 transmission mode insofar as the two SIB1 PDCCH and PDSCH repetition modes format PDCCH and PDSCH in complementary slots of the two consecutive slots. The first UE may monitor for PDCCH in slot n0+1 (e.g., based at least in part on not detecting PDCCH in slot n0). Based at least in part on detecting PDCCH in slot n0+1, the first UE may decode PDSCH via a non-repetition-based procedure. Decoding the PDSCH may be conditional on the first UE detecting that DCI carried by the PDCCH in slot n0+1 includes a CRC that is scrambled with an SI-RNTI. The second UE may also monitor and detect PDCCH and PDSCH in slot n0+1 in a similar manner as the first UE. In some aspects, the mode2 transmission mode may be backward compatible based at least in part on the first UE and the second UE being able to detect and decode PDCCH and PDSCH that is transmitted using the non-repetition-based procedure.

A third SIB1 PDCCH and PDSCH repetition transmission mode 506, which may also be referred to as a mode3 transmission mode, includes PDSCH repetition (e.g., PDSCH content repetition) and does not include PDCCH repetition. In slot n0 of the mode3 transmission mode, PDCCH and PDSCH are transmitted, and slot n0+1 includes a PDSCH repetition (but not a PDCCH repetition). The first UE may monitor for PDCCH in slot n0 and, based at least in part on detecting PDCCH in slot n0, decode PDSCH via a non-repetition-based procedure. Decoding the PDSCH may be conditional on the first UE detecting that DCI carried by the PDCCH in slot n0 includes CRC that is scrambled with an SI-RNTI. The first UE may skip monitoring slot n0+1 based at least in part on successful detection and decoding of the PDCCH and the PDSCH in slot n0. The second UE may also monitor slot n0 and detect PDCCH and PDSCH. The second UE may buffer the received PDSCH from slot n0, may combine the PDSCH received in slot n0 with PDSCH received in slot n0+1, and may decode the combined PDSCH, which may also be referred to as a PDSCH combining procedure. In some aspects, the second UE may determine to perform the PDSCH combining procedure based at least in part on detecting errors in the decoding of PDSCH in slot n0. The mode3 transmission mode may be backward compatible based at least in part on the first UE being able to detect and decode PDCCH and PDSCH that is transmitted in slot n0 using the non-repetition-based procedure. The second UE is able to use the PDSCH combining procedure to increase the likelihood of a successful SIB1 recovery.

A fourth SIB1 PDCCH and PDSCH repetition transmission mode 508, which may also be referred to as a mode4 transmission mode, includes PDCCH repetition (e.g., PDCCH content repetition) and includes PDSCH repetition (e.g., PDSCH content repetition). In the mode4 transmission mode, slot n0 and slot n0+1 of the mode4 transmission mode each carry PDCCH and PDSCH. The first UE may monitor for PDCCH in slot n0 and, based at least in part on detecting PDCCH in slot n0, may decode PDSCH via a non-repetition-based procedure. Decoding the PDSCH may be conditional on the first UE detecting that DCI carried by the PDCCH in slot n0 includes CRC that is scrambled with an SI-RNTI. In some cases, the first UE may fail to detect PDCCH in slot n0, resulting in the first UE not decoding PDSCH in slot n0. Instead, the first UE may detect PDCCH in slot n0+1 and may decode PDSCH in slot n0+1 using a non-repetition-based procedure.

The second UE may also monitor slot n0 and detect PDCCH and PDSCH. Based at least in part on the second UE having SIB1 PDCCH and PDSCH repetition capabilities, the second UE may buffer the detected PDCCH from slot n0, may buffer the PDSCH from slot n0, or may perform a combination of the two. The second UE may also monitor slot n0+1 for PDCCH and PDSCH. The second UE may combine the PDCCH received in slot n0 with the PDCCH received in slot n0+1, and may decode the combined PDCCH, which may also be referred to as a PDCCH combining procedure. The second UE may also perform a PDSCH combining procedure that uses repetitions of the PDSCH, such as the PDSCH received in slot n0 and the PDSCH received in slot n0+1. The mode4 transmission mode may be backward compatible based at least in part on the first UE being able to detect and decode PDCCH and PDSCH that is transmitted in slot n0, or slot n0+1, using the non-repetition-based procedure. The second UE is able to use a PDCCH combining procedure, a PDSCH combining procedure, or a combination of the two, to recover SIB1.

As indicated above, FIG. 5 is provided as an example. Other examples may differ from what is described with regard to FIG. 5.

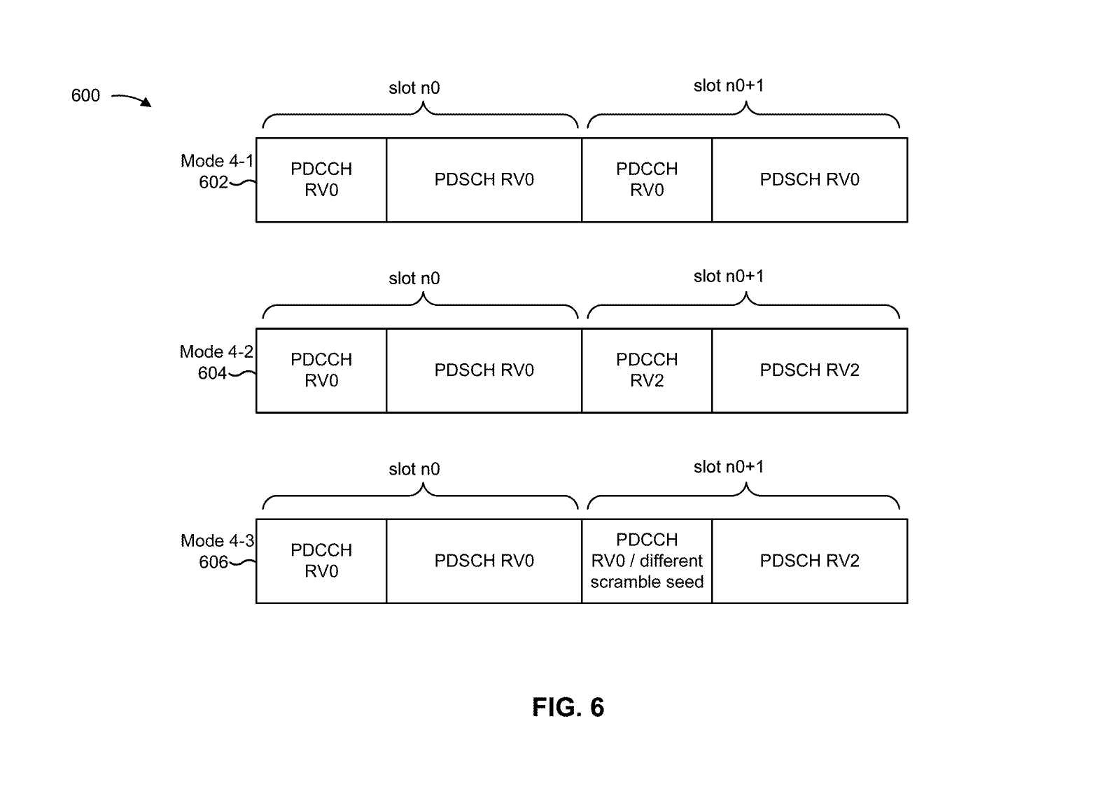

FIG. 6 is a diagram illustrating an example 600 of mode4 transmission mode configurations that may be used for SIB1 PDCCH repetition and PDSCH repetition.

The example 600 includes three configuration variations for the mode4 transmission mode that includes PDCCH repetition and PDSCH repetition for a SIB1 related transmission as described with regard to FIG. 5. In some aspects, a communication standard may specify one or more mode4 transmission mode configurations. Alternatively, or additionally, the communication standard may link a particular mode4 transmission mode configuration to a particular deployment configuration.

A first mode4 transmission mode configuration 602, which may alternatively be referred to as a mode4-1 transmission mode, includes PDCCH and PDSCH in slot n0. The PDCCH in slot n0 indicates that the PDSCH in slot n0 is encoded using a first redundancy version (RV) that is shown in FIG. 6 as being RV0. The first mode4 transmission mode configuration 602 also includes PDCCH and PDSCH in slot n0+1, and the PDCCH in slot n0+1 indicates that the PDSCH in slot n0+1 is encoded also using the first RV. Based at least in part on the PDSCH in slot n0 and the PDSCH in slot n0+1 using a same RV, the PDCCH in slot n0 and the PDCCH in slot n0+1 may include the same content and/or may indicate a same RV used for PDSCH encoding.

In decoding a SIB1 related transmission that is formatted using the mode4-1 transmission mode, a first UE (e.g., a legacy UE) may decode PDCCH and PDSCH in slot n0 or slot n0+1 using the RV indicated in the respective PDCCH and a non-repetition-based procedure. For instance, the first UE may decode PDSCH in slot n0 using an RV indicated by the PDCCH in slot n0, and may decode PDSCH in slot n0+1 using an RV indicated by the PDCCH in slot n0+1. For a second UE that supports SIB1 PDCCH repetition and PDSCH repetition, the second UE may use a PDCCH combining procedure that generates a combined PDCCH using an expectation (e.g., as specified by a communication standard) that a PDCCH payload for the PDCCH in slot n0+1 is the same payload as a PDCCH payload for the PDCCH in slot n0, and the second UE may decode the combined PDCCH. Alternatively, or additionally, the second UE may generate a combined PDSCH using PDSCH combining and based at least in part on an expectation that the PDSCH in slot n0+1 uses a same RV as the PDSCH in slot n0, and may decode the combined PDSCH.

A second mode4 transmission mode configuration 604, which may alternatively be referred to as a mode4-2 transmission mode, includes PDCCH and PDSCH in slot n0 and slot n0+1. The PDCCH in slot n0 indicates that the PDSCH in slot n0 is encoded using a first RV (e.g., RV0), and the PDCCH in slot n0+1 indicates that the PDSCH in slot n0+1 is encoded using a second RV that is shown in FIG. 6 as RV2.

To decode a SIB1 related transmission that is formatted using the mode4-2 transmission mode, the first UE may decode PDCCH and PDSCH in slot n0 or slot n0+1 using a non-repetition-based procedure. The second UE may generate a combined PDCCH using PDCCH combining and based at least in part on an expectation (e.g., as specified by a communication standard) that a first RV indicated in the PDCCH in slot n0 is different than a second RV indicated by the PDCCH in slot n0+1. In some aspects, the PDCCH combining may be based at least in part on an expectation (e.g., as specified by a communication standard) that a most significant bit (MSB) or a least significant bit (LSB) of a first RV field in a first PDCCH carried in slot n0 is flipped (e.g., opposite bit values) relative to a second RV field in a second PDCCH carried in slot n0+1. The second UE may decode the combined PDCCH.

Alternatively, or additionally, the second UE may generate a combined PDSCH using PDSCH combining and based at least in part on an expectation that the PDSCH in slot n0+1 uses a different RV than the PDSCH in slot n0. One example of an expectation includes being able to determine the RV used for PDSCH in slot n0+1 using a rule that is specified by a communication standard (e.g., a pre-determined rule). For instance, the communication standard may specify, and the second UE may use or expect the RV to follow, a rule that specifies that the RV of the second PDSCH in slot n0+1 (e.g., RVʹ) may be computed as (RV+2) modulo 4, where RV is the RV of the first PDSCH in slot n0.

A third mode4 transmission mode configuration 606, which may alternatively be referred to as a mode4-3 transmission mode, includes PDCCH and PDSCH in slot n0 and slot n0+1. The PDCCH in slot n0 indicates that the PDSCH in slot n0 is encoded using a first RV (e.g., RV0), and the PDCCH in slot n0+1 indicates that the PDSCH in slot n0+1 is encoded using the first RV (e.g., RV0). However, the PDCCH in slot n0+1 may be scrambled with a different seed value relative to the PDCCH in slot n0. Scrambling the PDCCH in slot n0+1 with a different seed value relative to the PDCCH in slot n0 may prevent the first UE from detecting or decoding the PDCCH in slot n0+1, while the second UE may decode the PDCCH in slot n0+1 based at least in part on an expectation that the PDCCH in slot n0+1 is scrambled with the different seed value. In some aspects, a communication standard may specify or indicate the different seed value, such as by specifying an absolute seed value or specifying a delta (e.g., difference) seed value that is relative to a scrambling seed value used for the PDCCH in slot n0.

In decoding a SIB1 related transmission that is formatted using the mode4-3 transmission mode, the first UE may decode PDCCH and PDSCH in slot n0 using a non-repetition-based procedure. As described above, the first UE may be unable to decode PDSCH in slot n0+1 based at least in part on the PDCCH in slot n0+1 being scrambled using a different seed value than the PDCCH in slot n0. The second UE may generate a combined PDCCH using PDCCH combining and based at least in part on an expectation (e.g., as specified by a communication standard) that PDCCH in slot n0 uses a first scrambling seed that is different from a second seed value used to scramble the PDCCH in slot n0+1. Alternatively, or additionally, the second UE may generate a combined PDSCH using PDSCH combining and based at least in part on an expectation that the PDSCH in slot n0+1 uses a different RV than the PDSCH in slot n0. One example of an expectation includes being able to determine the RV used for PDSCH in slot n0+1 using a rule that is specified by a communication standard (e.g., a pre-determined rule). For instance, the communication standard may specify, and the second UE may use or expect the RV to follow, a rule that specifies that the RV of the second PDSCH in slot n0+1 (e.g., RVʹ) may be computed as (RV+2) modulo 4, where RV is the RV of the first PDSCH in slot n0.

As indicated above, FIG. 6 is provided as an example. Other examples may differ from what is described with regard to FIG. 6.

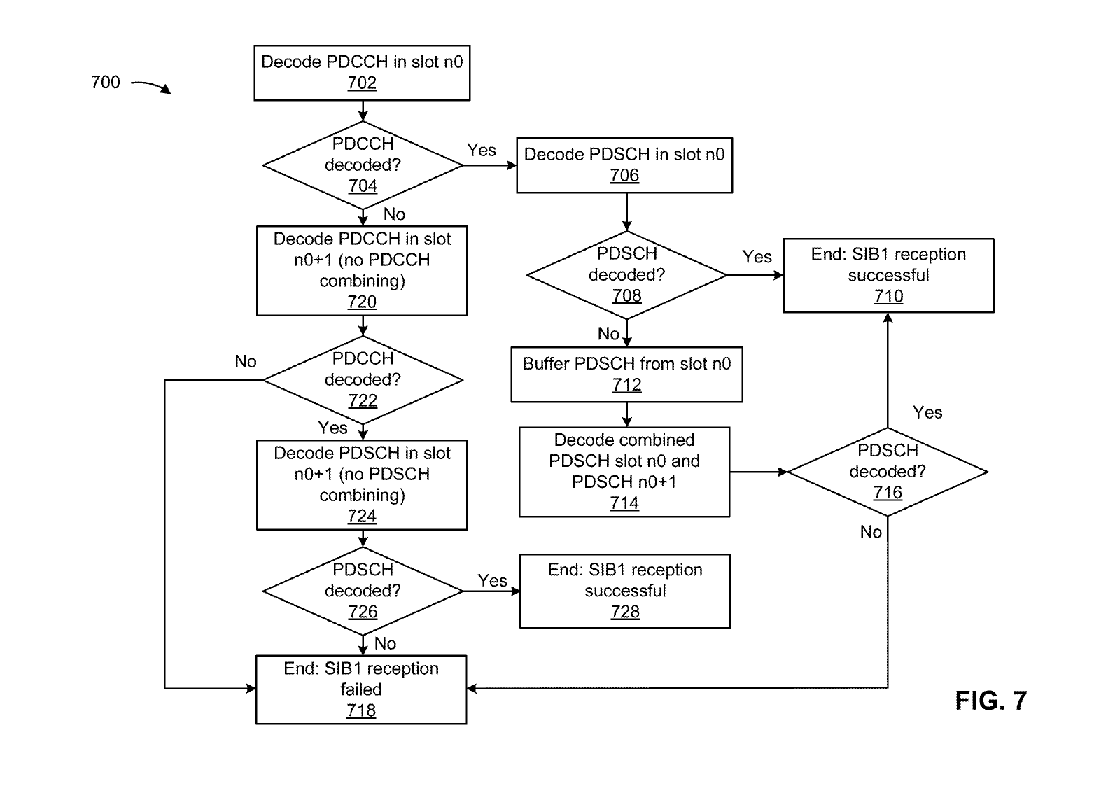

FIG. 7 is an example flow diagram 700 of steps in a process that may be included in a SIB1 processing procedure that may be performed by a UE (e.g., a UE 120) for processing a SIB1 related transmission. In some aspects, the procedure may be performed in a scenario that is based at least in part on two consecutive slots in a SIB HARQ retransmission occasion (e.g., HARQ retransmission occasion 406 described with regard to FIG. 4) being allocated to a SIB1 related transmission. Portions of the process shown by the flow diagram 700 may be performed by a first UE that does not include support for SIB1 PDCCH repetition and PDSCH repetition, and portions of the process shown by the flow diagram 700 may be performed by a second UE that includes support for SIB1 PDCCH repetition and PDSCH repetition.

As described with regard to FIG. 6, a SIB1 PDCCH repetition and PDSCH repetition state (e.g., enabled or disabled) may be linked to a particular deployment configuration. In some aspects, the particular deployment configuration may be linked to a combination of SIB1 PDCCH repetition and PDSCH repetition transmission modes, and a network node may have flexibility to select a particular SIB1 PDCCH repetition and PDSCH repetition transmission mode from the combination to use in transmitting a SIB1 related transmission. To illustrate, in a similar manner as described with regard to FIG. 6, a communication standard may specify a linkage between a particular deployment configuration and a combination of potential SIB1 PDCCH repetition and PDSCH repetition transmission modes that are supported and may be used in the particular deployment configuration.

As one example, the communication standard may specify that a first particular deployment configuration is linked to a first combination of supported SIB1 PDCCH repetition and PDSCH repetition transmission modes that includes the mode1 transmission mode and the mode2 transmission mode. Alternatively, or additionally, the communication standard may specify that a second particular deployment configuration is linked to a second combination of supported SIB1 PDCCH repetition and PDSCH repetition transmission modes that includes the mode1 transmission mode, the mode2 transmission mode, and the mode3 transmission mode. In another example, the communication standard may specify that a third particular deployment configuration is linked to a third combination of supported SIB1 PDCCH repetition and PDSCH repetition transmission modes that includes the mode1 transmission mode and the mode3 transmission mode, or that a fourth particular deployment configuration is linked to a fourth combination of supported SIB1 PDCCH repetition and PDSCH repetition transmission modes that includes the mode1 transmission mode, the mode2 transmission mode, and the mode4 transmission mode. In yet another example, the communication standard may specify that a fifth particular deployment configuration is linked to a fifth combination of supported SIB1 PDCCH repetition and PDSCH repetition transmission modes that includes the mode1 transmission mode and the mode4 transmission mode. Any combination of the combination examples may be used by a communication standard for any number of deployment configurations.

For the first combination described above (e.g., the mode1 transmission mode and the mode2 transmission mode), a network node may transmit a SIB1 related transmission using either the mode1 transmission mode or the mode2 transmission mode, and a first UE that is a legacy UE may monitor for PDCCH in both slots n0 and n0+1. Based at least in part on detecting PDCCH in slot n0 (e.g., the mode1 transmission mode), the first UE may detect and decode PDSCH in slot n0. Based at least in part on failing to detect or decode PDCCH in slot n0, the first UE may monitor and detect PDCCH in slot n0+1 (e.g., the mode2 transmission mode) and, subsequently, detect and decode PDSCH in slot n0+1. The first UE may decode PDSCH (e.g., in slot n0 or slot n0+1) using a non-repetition-based procedure and based at least in part on detecting that DCI in the PDCCH (e.g., detected in slot n0 or slot n0+1) includes CRC that is scrambled with SI-RNTI.

A second UE that supports SIB1 PDCCH repetition and PDSCH repetition may monitor for PDCCH in slot n0. Based at least in part on detecting PDCCH in slot n0 (e.g., the mode1 transmission mode), the second UE may detect and decode PDSCH based at least in part on the second UE operating in a particular deployment configuration that supports the first combination. That is, the second UE may have an expectation that PDCCH repetition is not present and that PDSCH repetition is not present based at least in part on the particular deployment configuration being linked to the first combination. In some aspects, the second UE may skip monitoring for PDCCH in slot n0+1 based at least in part on detecting PDCCH in slot n0. Alternatively, based at least in part on not detecting PDCCH in slot0, the second UE may monitor and detect PDCCH in slot n0+1 (e.g., the mode2 transmission mode) and, subsequently, detect and decode PDSCH in slot n0+1. In a similar manner as the first UE, the second UE may decode PDSCH (e.g., in slot n0 or slot n0+1) using a non-repetition-based procedure and based at least in part on detecting that DCI in the PDCCH (e.g., detected in slot n0 or slot n0+1) includes CRC that is scrambled with SI-RNTI.

As another example, the procedure described by flow diagram 700 includes steps that may be used for SIB processing by a UE for a deployment configuration that is linked to the second combination (e.g., the mode1 transmission mode, the mode2 transmission mode, and the mode3 transmission mode). The process begins at step 702 in which a UE (e.g., the first UE or the second UE) attempts to decode PDCCH in slot n0. In some cases, the UE may attempt to decode the PDCCH based at least in part on detecting the presence of the PDCCH in the slot. For example, as described above, the UE may first detect the presence of the PDCCH before proceeding to decode the corresponding information. The flow diagram proceeds to step 704 in which the UE determines whether PDCCH is successfully detected and decoded. Based at least in part on successfully decoding PDCCH, the UE may proceed as shown by the path marked “Yes” to step 706 in which the UE decodes PDSCH in slot n0. The UE may then proceed to step 708, in which the UE determines whether PDSCH was decoded successfully or whether to buffer the PDSCH from slot n0 to use in a PDSCH combining procedure.

With regard to step 708, in a first scenario, the UE may proceed as shown by the path labeled as “Yes” to step 710 when the UE has successfully decoded the PDSCH in slot n0, marking an end to the SIB1 processing procedure. In the first scenario, the UE (e.g., either the first UE or the second UE) processes the SIB1 related transmission as in the mode1 transmission mode using a non-repetition-based procedure. For instance, the first UE may only include support to process the SIB1 related transmission using the non-repetition-based procedure described above, and the second UE may determine to not use PDSCH combining based at least in part on successful decoding of PDSCH in slot n0. The first UE or the second UE may decode the PDSCH in slot n0 based at least in part on detecting that DCI in the PDCCH in slot n0 includes CRC that is scrambled with SI-RNTI.

In a second scenario with regard to step 708, the UE is the second UE and may proceed in a manner as shown by the path labeled as “No” to step 712 based at least in part on determining that PDSCH in slot n0 was unsuccessfully decoded. As at least part of step 712, the UE may buffer the PDSCH from slot n0. In some aspects, the UE may detect PDSCH in slot n0+1 and determine that the SIB1 related transmission uses the mode3 transmission mode. Accordingly, the UE may proceed to step 714 and perform a PDSCH combining procedure in which the UE combines the PDSCH in slot n0+1 with the PDSCH from slot n0 that is stored in the buffer to generate a combined PDSCH. The UE may decode the combined PDSCH and proceed to step 716 to determine whether the PDSCH was successfully decoded. Based at least in part on a successful decoding of the combined PDSCH, the UE may proceed as shown by the path marked “Yes” to step 710. Alternatively, based at least in part on unsuccessful decoding of the combined PDSCH, the UE may proceed as shown by the path marked “No” to step 718, resulting in an end to the SIB1 processing procedure in failure.

Returning to step 704, the UE may unsuccessfully decode the PDCCH from slot n0, which alternatively, or additionally include the UE unsuccessfully detecting the PDCCH from slot n0, and may proceed as shown by the path marked “No” to step 720. Based at least in part on the unsuccessful decoding of the PDCCH in slot n0 (which may alternatively, or additionally include the UE unsuccessfully detecting the PDCCH from slot n0), the UE may process the SIB1 related transmission as in the mode2 transmission mode. As part of step 720, the UE may detect PDCCH in slot n0+1 and may attempt to decode the PDCCH from slot n0+1. The UE, whether a first UE or a second UE, may process the PDCCH using a non-repetition-based procedure (e.g., without PDCCH combining). The UE may evaluate whether the decoding was successful, as shown by step 722. Based at least in part on failing to successfully decode the PDCCH in slot n0+1, the UE may proceed as shown by the path marked “No” to step 718 and end the SIB decoding procedure in failure. Based at least in part on successfully decoding the PDCCH in slot n0+1, the UE may proceed as shown by the path marked “Yes” to step 724. As at least part of step 724, the UE may decode the PDSCH using a non-repetition-based procedure (e.g., without PDSCH combining), where the decoding may be based at least in part on the UE detecting that DCI in the PDCCH in slot n0+1 includes CRC that is scrambled with SI-RNTI.

The UE may proceed to step 726 and evaluate whether decoding PDSCH in slot n0+1 was successful. Based at least in part on failing to successfully decode the PDSCH, the UE may proceed as shown by the path marked “No” to step 718, ending the SIB decoding procedure in failure. Alternatively, the UE may proceed as shown by the path marked “Yes” to step 728, where, similar to step 710, the UE has successfully decoded the PDSCH in slot n0+1, marking an end to the SIB1 processing procedure.

In summary, for a second combination of SIB1 PDCCH repetition and PDSCH repetition transmission modes that includes the mode1 transmission mode, the mode2 transmission mode, and the mode3 transmission mode, a UE may derive a particular SIB1 PDCCH and PDSCH repetition transmission mode used by a network node by processing slot n0 of two consecutive slots to detect a presence state (e.g., present or not present) of a first PDCCH in slot n0 and a decoding state (e.g., successful decoding or unsuccessful decoding) for a first PDSCH in slot n0. Based at least in part on at least one of the presence state of the first PDCCH and the decoding state of the first PDSCH, the UE may selectively process slot n0+1 of the two consecutive slots. In one example, the selective processing includes processing a combined PDSCH that is based at least in part on the first PDSCH and a second PDSCH in slot n0+1 as described with regard to step 714, such as in a scenario in which the presence state indicates that the first PDCCH is present and the decoding state indicates unsuccessful decoding of the first PDSCH. In a second example, the UE may decode a second PDCCH in slot n0+1 based at least in part on the presence state indicating that the first PDCCH is not present, and may decode the second PDSCH in the second slot without PDSCH combining.

As indicated above, FIG. 7 is provided as an example. Other examples may differ from what is described with regard to FIG. 7.

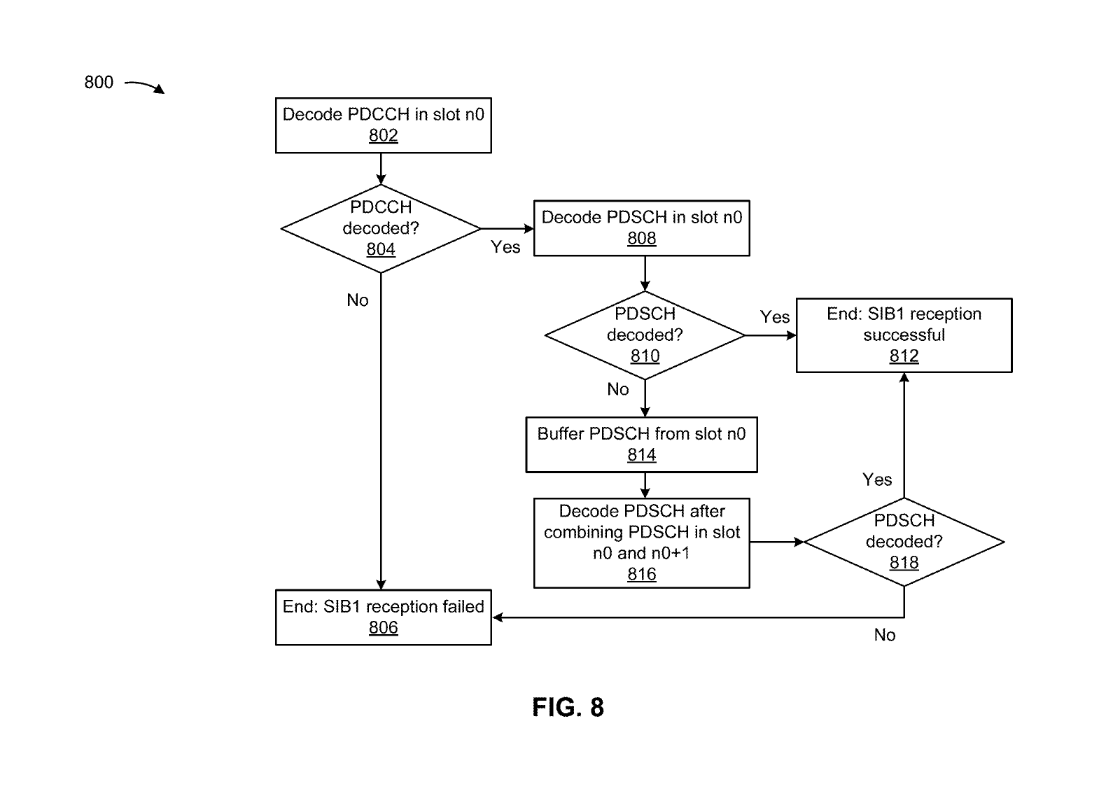

FIG. 8 is an example flow diagram 800 of steps in a process that may be included in a SIB1 processing procedure that may be performed by a UE (e.g., a UE 120) for processing a SIB1 related transmission. In some aspects, the process shown by the flow diagram 800 may be used by the UE to process a SIB1 related transmission that may be formatted as one of multiple SIB1 PDCCH repetition and PDSCH repetition transmission modes from the third combination described with regard to FIG. 8 (e.g., the mode1 transmission mode and the mode3 transmission mode). At least a first portion of the process shown by flow diagram 800 may be performed by a first UE that does not support SIB1 PDCCH repetition and PDSCH repetition, and at least a second portion of the process shown by the flow diagram 800 may be performed by a second UE that supports SIB1 PDCCH repetition and PDSCH repetition.

The flow diagram 800 begins at step 802 in which a UE (e.g., the first UE or the second UE) attempts to decode PDCCH in slot n0. In some cases, the UE may attempt to decode the PDCCH based at least in part on detecting the presence of the PDCCH in the slot. For example, as described above, the UE may first detect the presence of the PDCCH before proceeding to decode the corresponding information. The flow diagram 800 proceeds to step 804 in which the UE determines whether PDCCH is successfully detected and decoded. Based at least in part on failing to successfully detect PDCCH or decode PDCCH, the UE may proceed as shown by the path marked “No” to step 806, marking an end to the SIB1 processing procedure in failure.

Alternatively, the UE may proceed as shown by the path marked “Yes” to step 808 based at least in part on detecting successful decoding of PDCCH in slot n0. As at least part of step 808, the UE may attempt to decode PDSCH in slot n0, and may proceed to step 810 to determine whether the PDSCH was successfully decoded using a non-repetition-based procedure. Based at least in part on a successful decoding, the UE may proceed as shown by the path marked “Yes” to step 812 that marks a successful end to the SIB decoding procedure.

Alternatively, the UE may determine that the PDSCH in slot n0 was not decoded successfully and may proceed as shown by the path marked “No” to step 814. In some aspects, the UE may determine that the SIB1 related transmission uses a mode3 transmission. For some configurations, the UE is the second UE and, as at least part of step 814, the UE may buffer the PDSCH from slot n0. The UE may then proceed to step 816 may detect PDSCH in slot n0+1, and may perform a PDSCH combining procedure that combines the PDSCH in slot n0+1 with the buffered PDSCH from slot n0, and the UE may decode the combined PDSCH. Proceeding to step 818, the UE may determine whether the PDSCH was successfully decoded. In a first example, the UE may determine that the PDSCH was successfully decoded (e.g., using a mode3 transmission mode) and may proceed as shown by the path marked “Yes” to step 812, marking the end of a successful SIB1 decoding procedure. In a second example, the UE may determine that the PDSCH was not unsuccessfully decoded, and may proceed as shown by the path marked “No” to step 806, marking the end of the SIB1 decoding procedure in failure.

In summary, for a third combination of SIB1 PDCCH repetition and PDSCH repetition transmission modes that includes the mode1 transmission mode and the mode3 transmission mode, a UE may derive a particular SIB1 PDCCH and PDSCH repetition transmission mode used by a network node by processing slot n0 to detect a presence state of a first PDCCH in slot n0 and a decoding state of a first PDSCH in slot n0. The UE may selectively process slot n0+1 based at least in part on at least one of the presence state of the first PDCCH and the decoding state of the first PDSCH. In a first example of selective processing, the UE may decode a combined PDSCH using the first PDSCH in slot n0 and a second PDSCH in the slot n0+1 based at least in part on the presence state indicating a presence of the first PDCCH and the decoding state indicating that the first PDSCH is not successfully decoded. An example of the decoding state indicating that the first PDSCH is not successfully decoded may be a scenario in which PDSCH is not present in slot n0. In a second example of selective processing, the UE may skip decoding of a second PDCCH in slot n0+1, the UE may skip decoding of the second PDSCH in slot n0+1, or a combination of the two, based at least in part on the decoding state indicating that the first PDSCH was successfully decoded.

As indicated above, FIG. 8 is provided as an example. Other examples may differ from what is described with regard to FIG. 8.

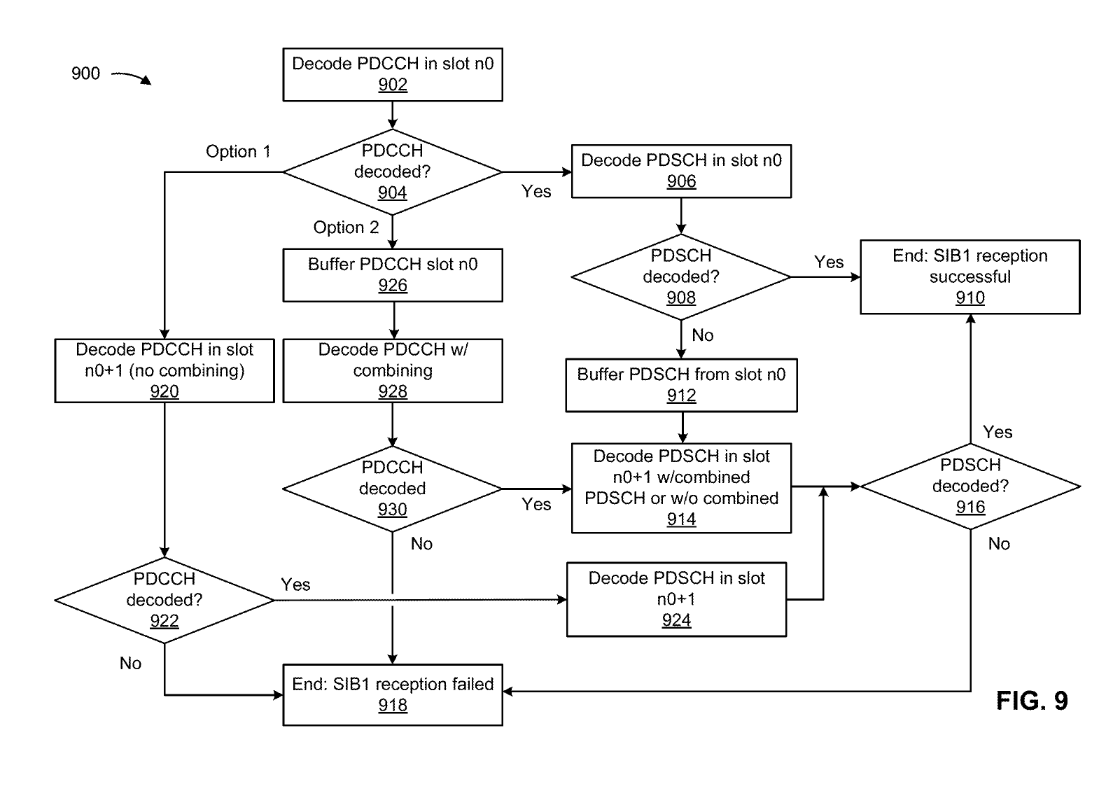

FIG. 9 is an example flow diagram 900 of steps in a process that may be included in a SIB1 processing procedure that may be performed by a UE (e.g., a UE 120) for processing a SIB1 related transmission. In some aspects, the process shown by the flow diagram 900 may be used by the UE to process a SIB1 related transmission that may be formatted as one of multiple SIB1 PDCCH repetition and PDSCH repetition transmission modes from the fourth combination described with regard to FIG. 8 (e.g., the mode1 transmission mode, the mode2 transmission mode, and the mode4 transmission mode). At least a first portion of the process shown by flow diagram 900 may be performed by a first UE that does not support SIB1 PDCCH repetition and PDSCH repetition, and at least a second portion of the process shown by the flow diagram 900 may be performed by a second UE that supports SIB1 PDCCH repetition and PDSCH repetition.

The flow diagram 900 begins at step 902 in which a UE (e.g., the first UE or the second UE) attempts to decode PDCCH in slot n0. In some cases, the UE may attempt to decode the PDCCH based at least in part on detecting the presence of the PDCCH in the slot. For example, as described above, the UE may first detect the presence of the PDCCH before proceeding to decode the corresponding information. The flow diagram 900 proceeds to step 904 in which the UE determines whether PDCCH is successfully detected and decoded. Based at least in part on successfully decoding PDCCH, the UE may proceed as shown by the path marked “Yes” to step 906 in which the UE decodes PDSCH in slot n0. The UE may then proceed to step 908, in which the UE determines whether PDSCH was decoded successfully or whether to buffer the PDSCH from slot n0 to use in a PDSCH combining procedure.

With regard to step 908, in a first scenario, the UE may determine that the PDSCH was successfully decoded and may proceed as shown by the path labeled as “Yes” to step 910 in which the UE has decoded the PDSCH in slot n0 successfully, marking an end to the SIB1 processing procedure. In the first scenario, the UE processes the SIB1 related transmission as in the mode1 transmission mode. The UE may be the first UE or the second UE and may process the SIB1 related transmission using a non-repetition-based procedure. For instance, the first UE may only include support to process the SIB1 using the non-repetition-based procedure described above, and the second UE may determine to not proceed with additional steps of the flow diagram 900 based at least in part on successfully decoding the PDSCH in slot n0. Decoding the PDSCH in the first scenario may be based at least in part on the UE detecting that DCI in the PDCCH in slot n0 includes CRC that is scrambled with SI-RNTI.

In a second scenario with regard to step 908, the UE is the second UE and may proceed as shown by the path labeled as “No” to step 912 based at least in part on determining that PDSCH in slot n0 was unsuccessfully decoded. As at least part of step 912, the UE may buffer the PDSCH from slot n0, may detect PDSCH in slot n0+1, and may proceed to step 914 and perform a PDSCH combining procedure that generates a combined PDSCH using the PDSCH in slot n0+1 and the PDSCH in slot n0. As shown by FIG. 9, the UE may attempt to decode the combined PDSCH, and may proceed to step 916 to determine whether the combined PDSCH was successfully decoded. In some aspects, as described below with regard to step 930, step 914 may alternatively include decoding PDSCH in slot n0+1 without the use of combining. Based at least in part on successfully decoding the combined PDSCH, the UE may proceed as shown by the path marked “Yes” to step 910 that marks the end of a successful SIB1 decoding procedure. Alternatively, based at least in part on unsuccessfully decoding the PDSCH, the UE may proceed as shown by the path marked “No” to step 918, resulting in an end to the SIB1 decoding procedure in failure.

Returning to step 904, the UE may determine that the PDCCH from slot n0 was unsuccessfully detected or that the PDCCH from slot n0 was unsuccessfully decoded. As a first option, the UE (e.g., the first UE or the second UE) may proceed as shown by the path marked as “Option 1”. As a second option, the UE may be a second UE (e.g. a UE that supports SIB1 PDCCH repetition and PDSCH repetition) and may proceed as shown by the path marked “Option 2”.

In the first option, the UE may proceed to step 920 and attempt to decode PDCCH in slot n0+1 using a non-repetition-based procedure and without performing PDCCH combining. The UE may then proceed to step 922 and determine whether the PDCCH in slot n0+1 was decoded successfully. Based at least in part on unsuccessfully decoding the PDCCH in slot n0+1, the UE may proceed to step 918, marking the end to the SIB1 decoding procedure in failure. Alternatively, based at least in part on successfully decoding the PDCCH in slot n0+1, the UE may proceed to step 924 and attempt to decode PDSCH in slot n0+1. The UE may proceed to step 916 to determine whether the PDSCH was decoded successfully. Based at least in part on unsuccessful decoding of the PDSCH, the UE may proceed as shown by the path marked “No” to step 918. Alternatively, based at least in part on successful decoding of the PDSCH, the UE may proceed as shown by the path marked “Yes” to step 910.

In the second option, in which the UE is the second UE, the UE may proceed to step 926. As part of step 926, the UE may buffer PDCCH in slot n0 and may attempt to detect PDCCH in slot n0+1. The UE may proceed to step 928 and perform a PDCCH combining procedure to generate a combined PDCCH that is based at least in part on the PDCCH in slot n0 and the PDCCH in slot n0+1, and may attempt to decode the combined PDCCH. The UE may proceed to step 930 to determine whether the combined PDCCH was successfully decoded. Based at least in part on unsuccessful decoding of the combined PDCCH, the UE may proceed as shown by the path marked “No” to step 918, marking an end to the SIB decoding procedure in failure. Based at least in part on successfully decoding the combined PDCCH, the UE may proceed as shown by the path marked “Yes” to step 914. As at least part of step 914, the UE may generate a combined PDSCH using a PDSCH combining procedure as described above, and may attempt to decode the combined PDCCH. In other aspects, as at least part of step 914, the UE may decode PDSCH in slot n0+1 without the use of combining. The UE may proceed to step 916 and step 910 based at least in part on successfully decoding the combined PDSCH (or the singular PDSCH in slot n0+1), and may proceed to step 916 and step 918 based at least in part on unsuccessfully decoding the combined PDSCH.

In summary, for a fourth combination of SIB1 PDCCH repetition and PDSCH repetition transmission modes that includes the mode1 transmission mode, the mode2 transmission mode, and the mode4 transmission mode, a UE may derive a particular SIB1 PDCCH and PDSCH repetition transmission mode used by a network node by processing slot n0 to detect a presence state of a first PDCCH in slot n0 and a decoding state of a first PDSCH in slot n0. The UE may selectively process slot n0+1 based at least in part on at least one of the presence state of the first PDCCH and the decoding state of the first PDSCH. In a first example of selective processing, the UE may decode a combined PDSCH that is based at least in part on the first PDSCH and a second PDSCH in slot n0+1. In a second example of selective processing, the UE may decode a second PDCCH in the slot n0+1 using a non-repetition-based procedure and may decode PDSCH in the slot n0+1 using a non-repetition-based procedure. In a third example of selective processing, the UE may decode a combined PDCCH using a PDCCH combining procedure that combines PDCCH in slot n0 with PDCCH in slot n0+1. Alternatively, or additionally, as part of the third example, the UE may decode a combined PDSCH using a PDSCH combining procedure that combines PDSCH in slot n0 with PDSCH in slot n0+1.

As indicated above, FIG. 9 is provided as an example. Other examples may differ from what is described with regard to FIG. 9.

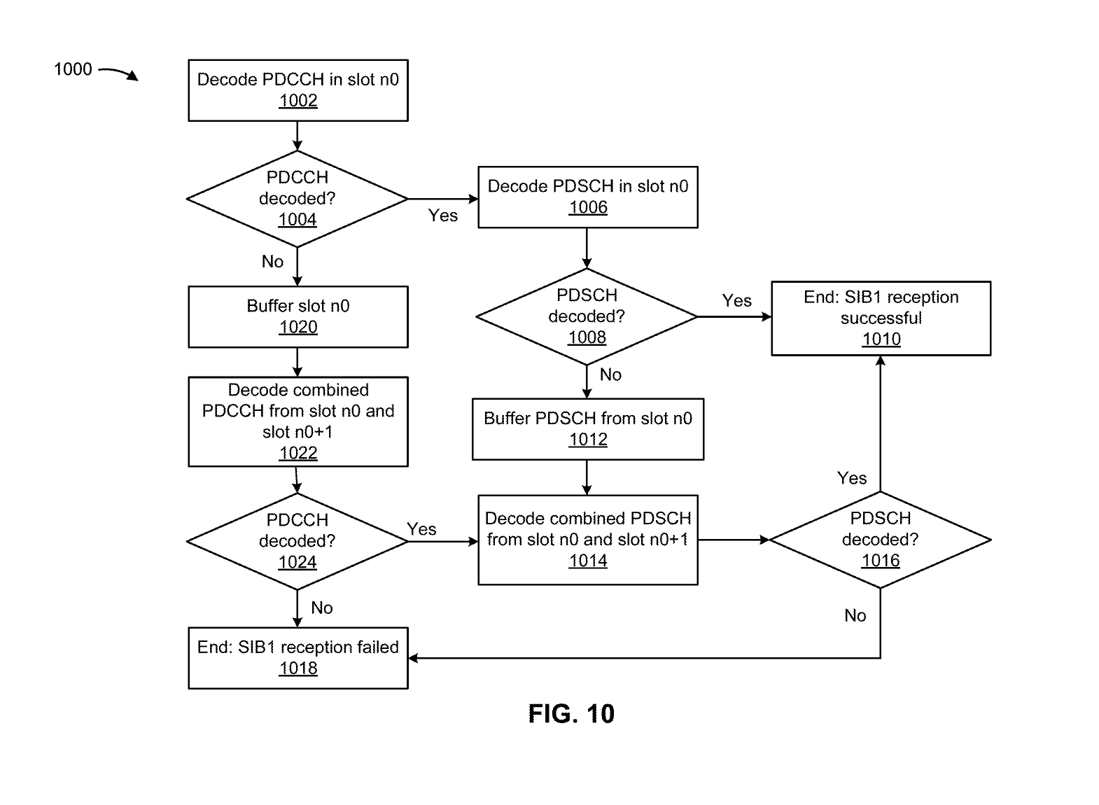

FIG. 10 is a diagram illustrating an example flow diagram 1000 of steps in a process that may be included in a SIB1 processing procedure that may be performed by a UE (e.g., a UE 120) for processing a SIB1 related transmission. In some aspects, the process shown by the flow diagram 1000 may be used by the UE to process a SIB1 related transmission that may be formatted as one of multiple SIB1 PDCCH repetition and PDSCH repetition transmission modes from the fifth combination described with regard to FIG. 8 (e.g., the mode1 transmission mode and the mode4 transmission mode). At least a first portion of the process shown by the flow diagram 1000 may be performed by a first UE that does not support SIB1 PDCCH repetition and PDSCH repetition, and at least a second portion of process shown by the flow diagram 1000 may be performed by a second UE that supports SIB1 PDCCH repetition and PDSCH repetition.

The flow diagram 1000 begins at step 1002 in which a UE (e.g., the first UE or the second UE) attempts to decode PDCCH in slot n0. In some cases, the UE may attempt to decode the PDCCH based at least in part on detecting the presence of the PDCCH in the slot. For example, as described above, the UE may first detect the presence of the PDCCH before proceeding to decode the corresponding information. The flow diagram 1000 proceeds to step 1004 where the UE determines whether the PDCCH is successfully detected and decoded. Based at least in part on successfully decoding PDCCH, the UE may proceed as shown by the path marked “Yes” to step 1006 and may attempt to decode PDSCH in slot n0. The UE may then proceed to step 1008 and determine whether the PDSCH was successfully decoded. In a similar manner as described above, decoding the PDSCH in slot n0 may be based at least in part on the UE detecting that DCI carried by the PDCCH in slot n0 includes a CRC that is scrambled with an SI-RNTI.

With regard to step 1008, in a first scenario, the UE may determine that the PDSCH was successfully decoded, resulting in the UE proceeding as shown by the path labeled as “Yes” to step 1010, marking a successful end to the SIB1 processing procedure. The UE may be the first UE or the second UE that processes the SIB1 related transmission using a non-repetition-based procedure and the mode1 transmission mode. For instance, the first UE may only include support to process the SIB1 using the non-repetition-based procedure described above, and the second UE may determine to not proceed with additional steps of the flow diagram 1000 based at least in part on successfully decoding the PDSCH in slot n0.

In a second scenario with regard to step 1008, the UE is the second UE and may proceed as shown by the path labeled as “No” to step 1012 based at least in part on determining that PDSCH in slot n0 was unsuccessfully decoded. As at least part of step 1012, the UE may buffer the PDSCH from slot n0, may detect PDSCH in slot n0+1, and may proceed to step 1014 in which the UE performs a PDSCH combining procedure to generate a combined PDSCH using the PDSCH in slot n0+1 and the PDSCH in slot n0. As at least part of step 1014, the UE may attempt to decode the combined PDSCH. The UE may proceed to step 1016 and determine whether the combined PDSCH was successfully decoded. Based at least in part on the combined PDSCH being successfully decoded, the UE may proceed as shown by the path marked “Yes” to step 1010 that marks the end of a successful SIB1 decoding procedure. Alternatively, based at least in part on the PDSCH being unsuccessfully decoded, the UE may proceed as shown by the path marked “No” to step 1018, resulting in an end to the SIB1 decoding procedure in failure. As at least part of step 1014, a UE that includes support for SIB1 PDCCH and PDSCH repetition, the UE may perform combining as described above. Conversely, a UE that does not include support for SIB1 PDCCH and PDSCH repetition may attempt to decode the PDSCH in slot n0+1 without performing combining (e.g., without buffering the PDSCH from slot n0 as described with regard to step 1012). Accordingly, while FIG. 10 illustrates a UE buffering PDSCH from slot n0 as part of step 1012, and a UE performing PDSCH combining in step 1014, some aspects may include a UE (e.g. a UE that does not include support for SIB1 PDCCH and PDSCH repetition) not buffering PDSCH from slot n0 and not performing a PDSCH combining procedure.

Returning to step 1004, the UE may proceed as shown by the path marked “No” to step 1020 based at least in part on determining that the PDCCH in slot n0 was unsuccessfully decoded. As at least part of step 1020, the UE may buffer PDCCH in slot n0 and attempt to detect PDCCH in slot n0+1. The UE may proceed to step 1022 and may perform a PDCCH combining procedure that generates a combined PDCCH using the PDCCH in slot n0 and the PDCCH in slot n0+1. As shown by FIG. 10, the UE may decode the combined PDCCH and proceed to step 1024 to determine whether the combined PDCCH was successfully decoded. Based at least in part on unsuccessfully decoding the combined PDCCH, the UE may proceed as shown by the path marked “No” to step 1018, marking an end to the SIB decoding procedure in failure. Based at least in part on successfully decoding the combined PDCCH, the UE may proceed as shown by the path marked “Yes” to step 1014 where the UE may generate a combined PDSCH using a PDSCH combining procedure, and may attempt to decode the combined PDSCH as described above. The UE may proceed to step 1016 and step 1010 based at least in part on successfully decoding the combined PDSCH, or may proceed to step 1016 and step 1018 based at least in part on unsuccessfully decoding the combined PDSCH.

In summary, for a fifth combination of SIB1 PDCCH repetition and PDSCH repetition transmission modes that includes the mode1 transmission mode and the mode4 transmission mode, a UE may derive a particular SIB1 PDCCH and PDSCH repetition transmission mode used by a network node by processing slot n0 to detect a presence state of first PDCCH and a decoding state of first PDSCH. The UE may selectively process slot n0+1 based at least in part on at least one of the presence state of the first PDCCH and the decoding state of the first PDSCH. In a first example of selective processing, the UE may decode, based at least in part on the presence state indicating that the first PDCCH is present and the decoding state indicating that the first PDSCH is not decoded, a combined PDSCH that is based at least in part on the first PDSCH and a second PDSCH in slot n0+1. In a second example of selective processing, the UE may decode, based at least in part on the presence state indicating that the first PDCCH is not present and the decoding state indicating the first PDSCH is not decoded, a combined PDCCH based at least in part on a PDCCH combining procedure that uses PDCCH in slot n0 and PDCCH in slot n0+1 and, based at least in part on successful decoding of the combined PDCCH, the combined PDSCH.

As indicated above, FIG. 10 is provided as an example. Other examples may differ from what is described with regard to FIG. 10.

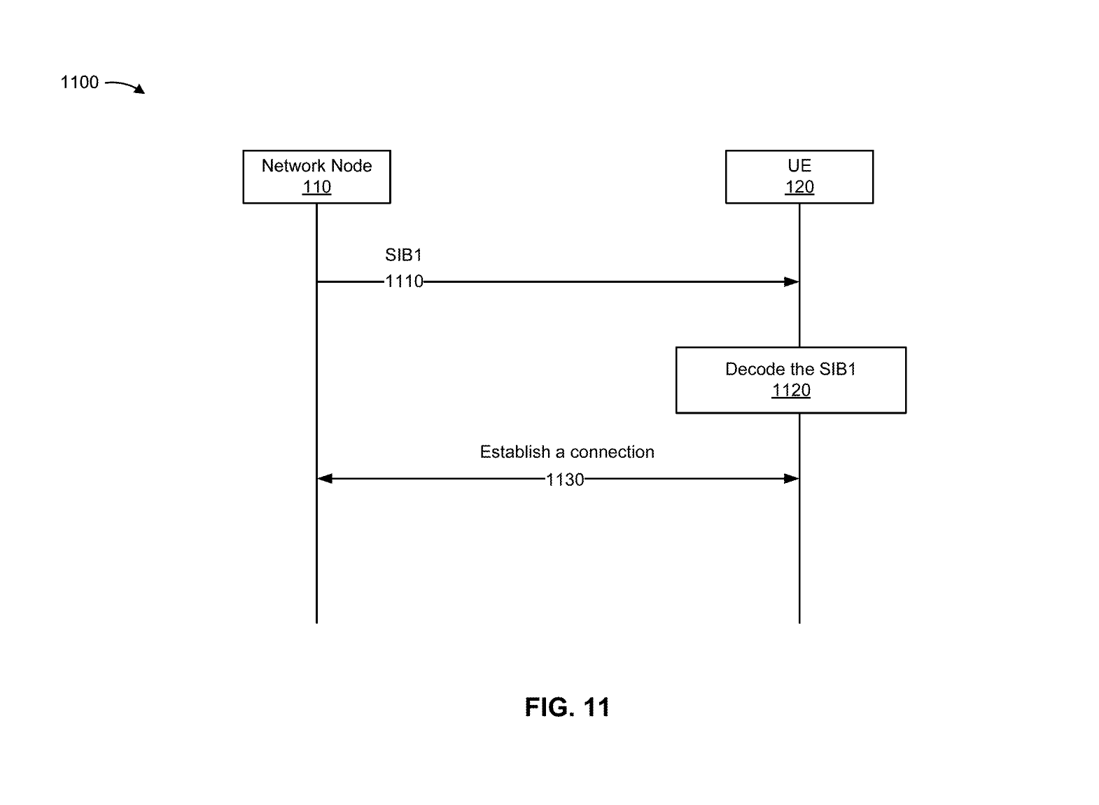

FIG. 11 is a diagram illustrating an example 1100 of a wireless communication process between a network node (e.g., the network node 110) and a UE (e.g., the UE 120), in accordance with the present disclosure. In some aspects, the network node may be an NTN network node as described with regard to FIG. 1 and FIG. 3.

As shown by reference number 1110, a network node 110 may transmit, and a UE 120 may receive, a SIB1 related transmission. In some aspects, the network node 110 may transmit, and the UE 120 may receive, the SIB1related transmission using a downlink channel repetition configuration, such as a SIB1 PDCCH repetition and PDSCH repetition transmission mode specified by a communication standard as described above. The network node 110 may transmit, and the UE 120 may receive, the SIB1 related transmission based at least in part on two consecutive slots that are assigned to the SIB1 related transmission (e.g. by a non-terrestrial network node or a terrestrial network node), such as the two consecutive slots 410 as described with regard to FIG. 4.

In some aspects, the UE 120 may monitor for the SIB using a particular deployment configuration (e.g., a particular frequency band), and a communication standard may link the particular deployment configuration to a particular downlink channel repetition configuration (e.g., one or more SIB1 PDCCH repetition and PDSCH repetition transmission modes) as described above, such as by specifying a linkage to a frequency band or a linkage that is based at least in part on a synchronization raster. In some aspects, the UE 120 may receive an indication of a PCI that is assigned to the network node 110, and the PCI may be linked to one or more SIB1 PDCCH repetition and PDSCH repetition transmission modes, such as through a linkage specified by a network operator or a linkage that is specified by a communication standard. Accordingly, the UE 120 may monitor for the SIB1 based at least in part on an expectation of a SIB1 PDCCH repetition and PDSCH repetition state (e.g., enabled or disabled) and a SIB1 PDCCH repetition and PDSCH repetition transmission mode as described above. In a similar manner, the network node 110 may transmit the SIB1 using a particular deployment configuration and a downlink channel repetition configuration that is linked to the particular deployment configuration.

In some aspects, the UE 120 may not receive any signaling that explicitly indicates the downlink channel repetition configuration of the SIB1 related transmission. However, in other examples, the UE 120 may receive explicit signaling that indicates the downlink channel repetition configuration, such as explicit signaling in a PBCH.

The downlink channel repetition configuration used by the network node 110 may be one of multiple SIB1 PDCCH and PDSCH repetition transmission modes, such as the mode1 transmission mode that does not include repetition in a second slot of the two consecutive slots, the mode2 transmission mode that does not include repetition in a first slot of the two consecutive slots, the mode3 transmission mode that does not include PDCCH repetition (e.g., PDCCH content repetition) and includes PDSCH repetition (e.g., PDSCH content repetition) in the two consecutive slots, or the mode4 transmission mode that includes the PDCCH repetition (e.g., PDCCH content repetition) and the PDSCH repetition (e.g., PDSCH content repetition) in the two consecutive slots as described with regard to FIG. 6.

As described with regard to FIG. 6, the mode4 transmission mode used by the network node 110 may include PDCCH repetition and PDSCH repetition in the two consecutive slots. A first example mode4 transmission mode or format may include PDSCH content being transmitted with a same RV in both of the two consecutive slots and PDCCH content being replicated in both of the two consecutive slots (e.g., the mode4-1 transmission mode). A second example mode4 transmission mode or format may include a first PDSCH in a first slot being encoded with a first RV and a second PDSCH in a second slot being encoded with a second RV. A first PDCCH in the first slot may indicate the first RV and a second PDCCH in the second slot may indicate the second RV (e.g., the mode4-2 transmission mode). A third example mode4 transmission mode or format may include PDSCH in a first slot being encoded with a first RV, and a first PDCCH of the PDCCH repetitions may indicate the first RV. A second PDCCH in the second slot may also indicate the first RV, where the second PDCCH is scrambled with a different seed than the first PDCCH (e.g., the mode4-3 transmission mode).

The network node 110 may select the downlink channel repetition configuration from two or more SIB1 PDCCH repetition and PDSCH repetition transmission modes, such as from a combination of potential SIB1 PDCCH repetition and PDSCH repetition transmission modes as described above with regard to FIGS. 7-10. Accordingly, the network node 110 may transmit the SIB1 using, as the downlink channel repetition configuration, a particular SIB1 PDCCH and PDSCH repetition transmission mode from the combination.

As shown by reference number 1120, the UE 120 may use a particular deployment to receive the SIB1 related transmission, and may decode the SIB1related transmission by processing at least one slot of the two consecutive slots using a downlink channel repetition configuration that has a linkage or an association to the particular deployment configuration. Processing the one slot (or both slots) of the two consecutive slots may include the UE 120 deriving the particular SIB1 PDCCH and PDSCH repetition transmission mode that is used as the downlink channel repetition configuration which, in some cases, may include deriving the particular SIB1 PDCCH repetition and PDSCH repetition transmission mode from the combination of SIB1 PDCCH repetition and PDSCH repetition transmission modes as described above.

In some aspects, the UE 120 may derive the particular SIB1 PDCCH and PDSCH repetition transmission mode using a non-repetition-based procedure. Alternatively, or additionally, the UE 120 may derive the particular SIB1 PDCCH and PDSCH repetition transmission mode by processing a first slot to detect a presence state (e.g., present or not present) of a first PDCCH in slot n0 and a decoding state (e.g., successful decoding or unsuccessful decoding) of a first PDSCH in slot n0. The UE 120 may then selectively process slot n0+1 based at least in part on the presence state, the decoding state, or a combination of both.

As one example, as described with regard to FIG. 8, the UE 120 may selectively decode a combined PDSCH that is based at least in part on the first PDSCH and a second PDSCH in the second slot of the two consecutive slots, based at least in part on the presence state indicating a presence of the first PDCCH and the decoding state indicating that the first PDSCH is not decoded successfully. As another example, the UE 120 may selectively decode a second PDCCH in the second slot and the second PDSCH in the second slot without PDSCH combining, based at least in part on the presence state indicating that the first PDCCH is not present.

Alternatively, or additionally, as described with regard to FIG. 8, the UE may selectively decode a combined PDSCH that uses the first PDSCH and a second PDSCH in the second slot based at least in part on the presence state indicating that the first PDCCH is present and the decoding state indicating that the first PDSCH is not decoded successfully. Alternatively, the UE may selectively skip decoding of a second PDCCH in the second slot and the second PDSCH in the second slot based at least in part on the presence state indicating that the first PDCCH is not present.

As described with regard to FIG. 10, the UE 120 may selectively decode a combined PDSCH that is based at least in part on the first PDSCH in the first slot and the second PDSCH in the second slot, based at least in part on the presence state indicating that the first PDCCH is present and the decoding state indicating that the first PDSCH is not decoded successfully. Alternatively, the UE may selectively monitor for second PDCCH in the second slot of the two consecutive slots, and decode the second PDCCH, without PDCCH combining, based at least in part on the presence state indicating that the first PDCCH is not present.

As described with regard to FIG. 10, the UE 120 may selectively decode a combined PDSCH that is based at least in part on the first PDSCH in the first slot and the second PDSCH in the second slot, and not decoding the second PDCCH in the second slot based at least in part on the presence state (e.g., a first presence state) indicating that the first PDCCH is present and the decoding state indicating that the first PDSCH is not decoded successfully. Alternatively, the UE 120 may selectively detect a presence state (e.g., a second presence state) of second PDCCH in the second slot based at least in part on the presence state of the first PDCCH indicating that the first PDCCH is not present, and may perform PDCCH combining that uses the first PDCCH and the second PDCCH. The UE 120 may then decode the combined PDSCH.

PDCCH combining performed by the UE 120 may be based at least in part on an expectation that a PDCCH payload of the first PDCCH in the first slot is duplicated in the second PDCCH in the second slot. Alternatively, or additionally, the UE 120 may perform PDSCH combining based at least in part on the first PDSCH in the first slot being encoded with an RV that is indicated by first PDCCH in the first slot and an expectation that the second PDSCH in the second slot uses the first RV. The UE 120 may perform PDSCH using the combined PDSCH.

In some aspects, the UE 120 may perform PDCCH combining based at least in part on an expectation that the first PDCCH in the first slot indicates the first RV and the second PDCCH in the second slot indicates the second RV. The UE 120 may perform PDCCH decoding using the combined PDCCH.

In some aspects, the UE 120 may perform PDSCH combining based at least in part on an expectation that the first PDSCH in the first slot uses (e.g., is encoded with) the first RV that is indicated by the first PDCCH, and the second PDSCH in the second slot uses the second RV that is indicated by second PDCCH in the second slot. The UE 120 may perform PDSCH decoding using the combined PDSCH.

The UE 120 may decode first PDCCH in the first slot based at least in part on a first scrambling seed. The UE may decode second PDCCH in the second slot based at least in part on a second scrambling seed that is different from the first scrambling seed and the RV. In some aspects, the UE may decode the PDCCH in the second slot using an expectation that the second PDCCH indicates an RV for decoding PDSCH in a first slot. That is, the UE may use an expectation that the second PDCCH indicates a same RV as the first PDCCH.

As shown by reference number 1130, the UE 120 and the network node 110 may establish a connection, where establishing the connection may be based at least in part on information obtained by the UE 120 from the SIB1. As one example, the SIB1 may include one or more random access parameters that the UE 120 may use to transmit a random access preamble to the network node 110 as part of a random access channel (RACH) procedure. The network node 110 may respond to the random access preamble with information that enables the UE 120 to establish a connection using radio resource control (RRC) signaling.

As indicated above, FIG. 11 is provided as an example. Other examples may differ from what is described with regard to FIG. 11.

FIG. 12 is a diagram illustrating an example process 1200 performed, for example, at a UE or an apparatus of a UE. Example process 1200 is an example where the apparatus or the UE (e.g., UE 120) performs operations associated with SIB1 downlink channel repetition using a deployment configuration.

As shown in FIG. 12, in some aspects, process 1200 may include receiving, using a particular deployment configuration, two consecutive slots that are assigned to a SIB1 related transmission of a non-terrestrial network (block 1210). For example, the UE (e.g., using reception component 1602 or communication manager 1606, depicted in FIG. 16) may receive, using a particular deployment configuration, two consecutive slots that are assigned to a SIB1 related transmission of a non-terrestrial network, as described above.

As further shown in FIG. 12, in some aspects, process 1200 may include processing at least one slot of the two consecutive slots using a downlink channel repetition configuration that has a linkage or an association to the particular deployment configuration (block 1220). For example, the UE (e.g., using communication manager 1606, depicted in FIG. 16) may process at least one slot of the two consecutive slots using a downlink channel repetition configuration that has a linkage or an association to the particular deployment configuration, as described above.

Process 1200 may include additional aspects, such as any single aspect or any combination of aspects described below or in connection with one or more other processes described elsewhere herein.

In a first aspect, the linkage or the association between the downlink channel repetition configuration and the particular deployment configuration is specified by a communication standard.

In a second aspect, the linkage or the association between the downlink channel repetition configuration and the particular deployment configuration is based at least in part on a frequency band.

In a third aspect, the linkage or the association between the downlink channel repetition configuration and the particular deployment configuration is based at least in part on a synchronization raster.

In a fourth aspect, the linkage or the association between the downlink channel repetition configuration and the particular deployment configuration is based at least in part on a PCI.

In a fifth aspect, the linkage or the association between the downlink channel repetition configuration and the particular deployment configuration is not indicated in PBCH signaling.

In a sixth aspect, the linkage or the association between the downlink channel repetition configuration and the particular deployment configuration is indicated in PBCH signaling.

In a seventh aspect, the downlink channel repetition configuration includes a SIB1 PDCCH and PDSCH repetition transmission mode.

In an eighth aspect, the SIB1 PDCCH and PDSCH repetition transmission mode includes at least one of a mode1 transmission mode that does not include repetition in a second slot of the two consecutive slots, a mode2 transmission mode that does not include repetition in a first slot of the two consecutive slots, a mode3 transmission mode that does not include PDCCH repetition (e.g., PDCCH content repetition) and includes PDSCH repetition (e.g., PDSCH content repetition) in the two consecutive slots, or a mode4 transmission mode that includes the PDCCH repetition (e.g., PDCCH content repetition) and the PDSCH repetition (e.g., PDSCH content repetition) in the two consecutive slots.

In a ninth aspect, the downlink channel repetition configuration includes a mode4 transmission mode that includes PDCCH repetition and PDSCH repetition in the two consecutive slots based at least in part on PDSCH content being transmitted with a same RV in both of the two consecutive slots and PDCCH content being replicated in both of the two consecutive slots, the PDSCH repetition being transmitted with a first RV in a first slot of the two consecutive slots and a second RV in a second slot of the two consecutive slots, a first PDCCH of the PDCCH repetition indicating the first RV and a second PDCCH of the PDCCH repetition indicating the second RV, or the PDSCH repetition being transmitted with the first RV in the first slot of the two consecutive slots and the second RV in the second slot of the two consecutive slots, the first PDCCH of the PDCCH repetition indicating the first RV and the second PDCCH of the PDCCH repetition indicating the first RV and being scrambled with a different seed than the first PDCCH.

In a tenth aspect, the downlink channel repetition configuration includes two or more SIB1 PDCCH and PDSCH repetition transmission modes, the two consecutive slots are configured as a particular SIB1 PDCCH and PDSCH repetition transmission mode of the two or more SIB1 PDCCH and PDSCH repetition transmission modes, and the processing includes deriving the particular SIB1 PDCCH and PDSCH repetition transmission mode.

In an eleventh aspect, the two or more SIB1 PDCCH and PDSCH repetition transmission modes include a mode1 transmission mode and a mode2 transmission mode, and deriving the particular SIB1 PDCCH and PDSCH repetition transmission mode includes deriving the particular SIB1 PDCCH and PDSCH repetition transmission mode using a non-repetition-based procedure.

In a twelfth aspect, the two or more SIB1 PDCCH and PDSCH repetition transmission modes include a mode1 transmission mode, a mode2 transmission mode, and a mode3 transmission mode, and deriving the particular SIB1 PDCCH and PDSCH repetition transmission mode includes processing a first slot of the two consecutive slots to detect a presence state of first PDCCH and a decoding state of first PDSCH, and processing, selectively and based at least in part on at least one of the presence state of the first PDCCH and the decoding state of the first PDSCH, a second slot of the two consecutive slots, the processing the second slot including decoding, based at least in part on the presence state indicating a presence of the first PDCCH and the decoding state indicating the first PDSCH is not decoded, a combined PDSCH that is based at least in part on the first PDSCH and a second PDSCH in the second slot of the two consecutive slots, or decoding, based at least in part on the presence state indicating the first PDCCH is not present, a second PDCCH in the second slot and the second PDSCH in the second slot without PDSCH combining.

In a thirteenth aspect, the two or more SIB1 PDCCH and PDSCH repetition transmission modes include a mode1 transmission mode and a mode3 transmission mode, and deriving the particular SIB1 PDCCH and PDSCH repetition transmission mode includes processing a first slot of the two consecutive slots to detect a presence state of first PDCCH and a decoding state of first PDSCH, and processing, selectively and based at least in part on at least one of the presence state of the first PDCCH and the decoding state of the first PDSCH, a second slot of the two consecutive slots, the processing the second slot including decoding, based at least in part on the presence state indicating a presence of the first PDCCH and the decoding state indicating the first PDSCH is not decoded, a combined PDSCH that is based at least in part on the first PDSCH and a second PDSCH in the second slot of the two consecutive slots, or skipping, based at least in part on the presence state indicating the first PDCCH is not present, decoding of a second PDCCH in the second slot and the second PDSCH in the second slot.

In a fourteenth aspect, the two or more SIB1 PDCCH and PDSCH repetition transmission modes include a mode1 transmission mode, a mode2 transmission mode, and a mode4 transmission mode, and deriving the particular SIB1 PDCCH and PDSCH repetition transmission mode includes processing a first slot of the two consecutive slots to detect a presence state of first PDCCH and a decoding state of first PDSCH, and processing, selectively and based at least in part on at least one of the presence state of the first PDCCH and the decoding state of the first PDSCH, a second slot of the two consecutive slots, the processing the second slot including decoding, based at least in part on the presence state indicating a presence of the first PDCCH and the decoding state indicating the first PDSCH is not decoded, a combined PDSCH that is based at least in part on the first PDSCH and a second PDSCH in the second slot of the two consecutive slots, or decoding, based at least in part on the presence state indicating the first PDCCH is not present, second PDCCH in the second slot of the two consecutive slots without PDCCH combining, decoding, based at least in part on the presence state indicating the first PDCCH is not present and the first PDSCH is not decoded, second PDCCH in the second slot without PDCCH combining, and a second PDSCH in the second slot without PDSCH combining, or decoding, based at least in part on the presence state indicating the first PDCCH is not present and the decoding state indicating the first PDSCH is not decoded, a combined PDCCH, that uses the first PDCCH and the second PDCCH, and the combined PDSCH.

In a fifteenth aspect, the two or more SIB1 PDCCH and PDSCH repetition transmission modes include a mode1 transmission mode and a mode4 transmission mode, and deriving the particular SIB1 PDCCH and PDSCH repetition transmission mode includes processing a first slot of the two consecutive slots to detect a first presence state of first PDCCH in the first slot and a decoding state of first PDSCH in the first slot, and processing, selectively and based at least in part on at least one of the first presence state of the first PDCCH and the decoding state of the first PDSCH, a second slot of the two consecutive slots, the processing the second slot including decoding, based at least in part on the first presence state indicating a presence of the first PDCCH and the decoding state indicating the first PDSCH is not decoded, a combined PDSCH that is based at least in part on the first PDSCH and a second PDSCH in the second slot of the two consecutive slots, or decoding, based at least in part on the presence state indicating the first PDCCH is not present, a combined PDCCH that is based at least in part on the first PDCCH and second PDCCH in the second slot, and, based at least in part on successful decoding of the combined PDCCH, combined PDSCH.

In a sixteenth aspect, process 1200 includes decoding, based at least in part on the second presence state indicating that the second PDCCH is present, the combined PDSCH.

In a seventeenth aspect, processing at least the one slot of the two consecutive slots includes performing PDCCH combining based at least in part on an expectation that a PDCCH payload of a first PDCCH in a first slot of the two consecutive slots is duplicated in a second PDCCH in a second slot of the two consecutive slots.

In an eighteenth aspect, processing at least the one slot of the two consecutive slots includes performing PDSCH decoding of a first PDSCH in a first slot of the two consecutive slots using a first RV indicated by first PDCCH in the first slot, and performing PDSCH decoding of a second PDSCH in a second slot of the two consecutive slots based at least in part on an expectation that the second PDSCH uses the first RV.

In a nineteenth aspect, processing at least the one slot of the two consecutive slots includes decoding first PDCCH in a first slot of the two consecutive slots using a first RV, and decoding second PDCCH in a second slot of the two consecutive slots using a second RV that is different from the first RV.

In a twentieth aspect, processing at least the one slot of the two consecutive slots includes performing PDSCH decoding of a first PDSCH in a first slot of the two consecutive slots using a first RV indicated by first PDCCH in the first slot, and performing PDSCH decoding of a second PDSCH in a second slot of the two consecutive slots based at least in part using a second RV indicated by second PDCCH in the second slot.

In a twenty-first aspect, processing at least the one slot of the two consecutive slots includes decoding first PDCCH in a first slot of the two consecutive slots based at least in part on a first scrambling seed, the first PDCCH indicating an RV, and decoding second PDCCH in a second slot of the two consecutive slots based at least in part on a second scrambling seed that is different from the first scrambling seed, the second PDCCH indicating the RV indicated by the first PDCCH.

In a twenty-second aspect, processing at least the one slot of the two consecutive slots includes decoding second PDCCH in a second slot of the two consecutive slots with an expectation that the second PDCCH indicates an RV for decoding PDSCH in a first slot of the two consecutive slots.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, at a network node or an apparatus of a network node. Example process 1300 is an example where the apparatus or the network node (e.g., network node 110) performs operations associated with SIB1 downlink channel repetition using a deployment configuration.

As shown in FIG. 13, in some aspects, process 1300 may include transmitting, using a particular deployment configuration, two consecutive slots that are assigned to a SIB1related transmission of a non-terrestrial network, the transmitting being based at least in part on a downlink channel repetition configuration that has a linkage or an association to the particular deployment configuration (block 1310). For example, the network node (e.g., using transmission component 1704 or communication manager 1706, depicted in FIG. 17) may transmit, using a particular deployment configuration, two consecutive slots that are assigned to a SIB1related transmission of a non-terrestrial network, the transmitting being based at least in part on a downlink channel repetition configuration that has a linkage or an association to the particular deployment configuration, as described above.

Process 1300 may include additional aspects, such as any single aspect or any combination of aspects described below or in connection with one or more other processes described elsewhere herein.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

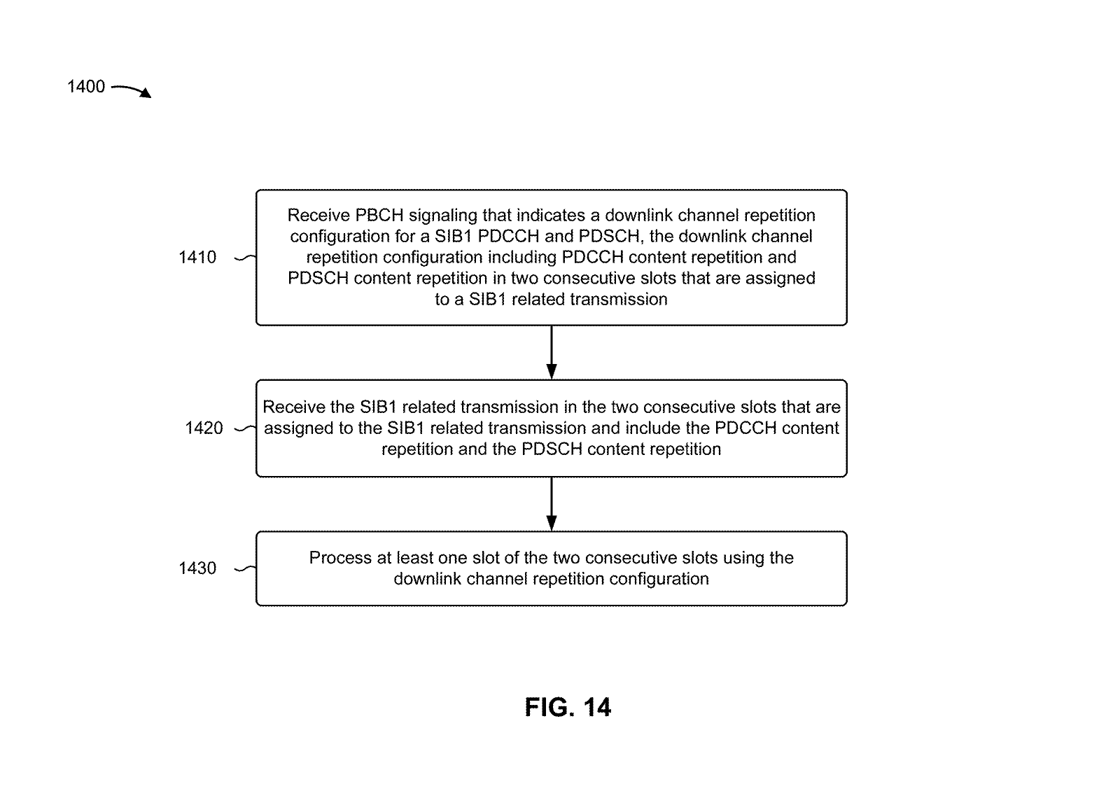

FIG. 14 is a diagram illustrating an example process 1400 performed, for example, at a UE or an apparatus of a UE. Example process 1400 is an example where the apparatus or the UE (e.g., UE 120) performs operations associated with SIB1 downlink channel repetition using a deployment configuration.

As shown in FIG. 14, in some aspects, process 1400 may include receiving PBCH signaling that indicates a downlink channel repetition configuration for a SIB1 PDCCH and PDSCH, the downlink channel repetition configuration including PDCCH content repetition and PDSCH content repetition in two consecutive slots that are assigned to a SIB1 related transmission (block 1410). For example, the UE (e.g., using reception component 1602 or communication manager 1606, depicted in FIG. 16) may receive PBCH signaling that indicates a downlink channel repetition configuration for an SIB1 PDCCH and PDSCH, the downlink channel repetition configuration including PDCCH content repetition and PDSCH content repetition in two consecutive slots that are assigned to a SIB1 related transmission, as described above.

As further shown in FIG. 14, in some aspects, process 1400 may include receiving the SIB1 related transmission in the two consecutive slots that are assigned to the SIB1 related transmission and include the PDCCH content repetition and the PDSCH content repetition (block 1420). For example, the UE (e.g., using reception component 1602 or communication manager 1606, depicted in FIG. 16) may receive the SIB1 related transmission in the two consecutive slots that are assigned to the SIB1 related transmission and include the PDCCH content repetition and the PDSCH content repetition, as described above.

As further shown in FIG. 14, in some aspects, process 1400 may include processing at least one slot of the two consecutive slots using the downlink channel repetition configuration (block 1430). For example, the UE (e.g., using communication manager 1606, depicted in FIG. 16) may process at least one slot of the two consecutive slots using the downlink channel repetition configuration, as described above.

Process 1400 may include additional aspects, such as any single aspect or any combination of aspects described below or in connection with one or more other processes described elsewhere herein.

In a first aspect, the PDCCH repetition and PDSCH repetition in the two consecutive slots includes PDSCH content being transmitted with a same RV in both of the two consecutive slots and PDCCH content being replicated in both of the two consecutive slots.

In a second aspect, process 1400 includes performing PDCCH combining based at least in part on an expectation that a PDCCH payload of a first PDCCH in a first slot of the two consecutive slots is duplicated in a second PDCCH in a second slot of the two consecutive slots.

In a third aspect, process 1400 includes performing PDSCH decoding of a first PDSCH in a first slot of the two consecutive slots using a first RV indicated by first PDCCH in a first slot of the two consecutive slots, and performing PDSCH decoding of a second PDSCH in a second slot of the two consecutive slots based at least in part on an expectation that the second PDSCH uses the first RV.

In a fourth aspect, the PBCH signaling includes a reserved bit that indicates the downlink channel repetition configuration for the SIB1 PDCCH and PDSCH.

In a fifth aspect, the reserved bit indicates an enabled state for the SIB1 PDCCH and PDSCH repetition.

In a sixth aspect, process 1400 includes selectively performing PDCCH combining or PDSCH combining based at least in part on a determination of at least one of: unsuccessful detection in a first slot of the two consecutive slots, or unsuccessful decoding in the first slot of the two consecutive slots.

In a seventh aspect, process 1400 includes determining the downlink channel repetition configuration based at least in part on a deployment configuration that includes at least one of a frequency band, a synchronization raster, or a PCI.

In an eighth aspect, the two consecutive slots are configured to be decoded using a non-repetition-based procedure.

In a ninth aspect, process 1400 includes buffering a first PDSCH from a first slot of the two consecutive slots and a second PDSCH from a second slot of the two consecutive slots, and decoding the SIB1 related transmission using a PDSCH combining procedure.

In a tenth aspect, process 1400 includes buffering a first PDCCH from a first slot of the two consecutive slots and a second PDCCH from a second slot of the two consecutive slots, and decoding the first PDCCH and the second PDCCH using a PDCCH combining procedure.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

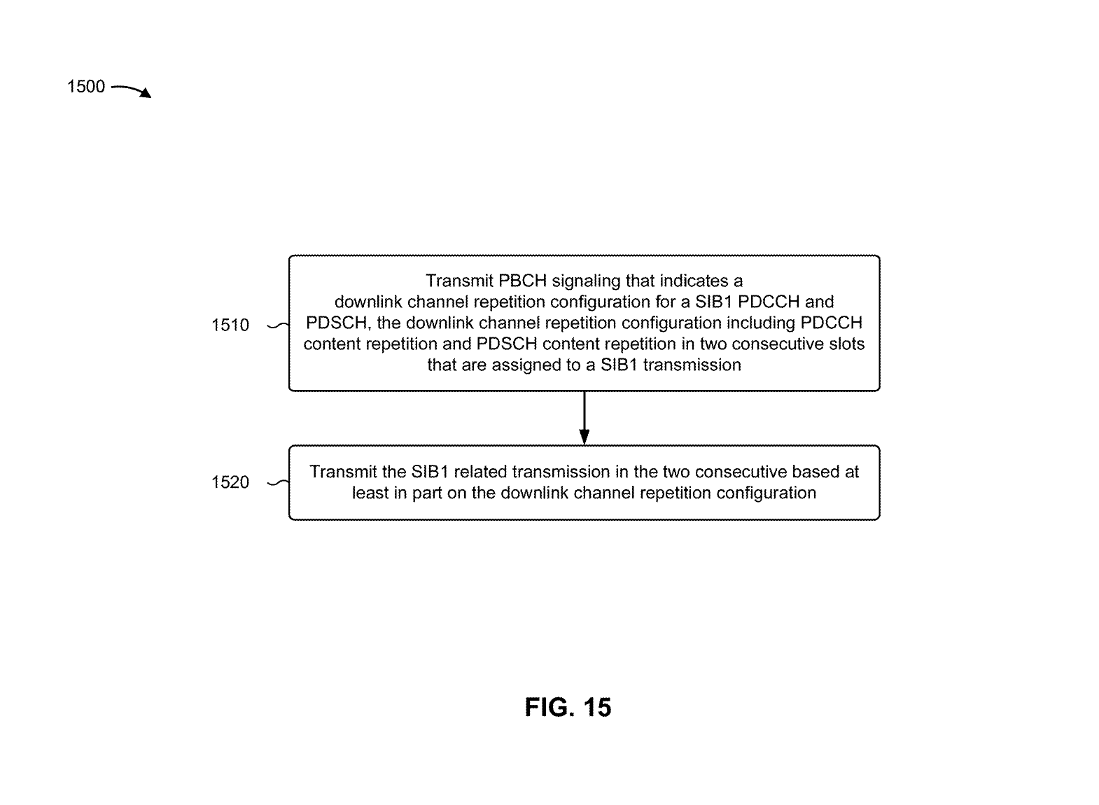

FIG. 15 is a diagram illustrating an example process 1500 performed, for example, at a network node or an apparatus of a network node. Example process 1500 is an example where the apparatus or the network node (e.g., network node 110) performs operations associated with SIB1 downlink channel repetition using a deployment configuration.

As shown in FIG. 15, in some aspects, process 1500 may include transmitting PBCH signaling that indicates a downlink channel repetition configuration for an SIB1 PDCCH and PDSCH, the downlink channel repetition configuration including PDCCH content repetition and PDSCH content repetition in two consecutive slots that are assigned to a SIB1 related transmission (block 1510). For example, the network node (e.g., using transmission component 1704 or communication manager 1706, depicted in FIG. 17) may transmit PBCH signaling that indicates a downlink channel repetition configuration for an SIB1 PDCCH and PDSCH, the downlink channel repetition configuration including PDCCH content repetition and PDSCH content repetition in two consecutive slots that are assigned to a SIB1 related transmission, as described above.

As further shown in FIG. 15, in some aspects, process 1500 may include transmitting the SIB1 related transmission in the two consecutive based at least in part on the downlink channel repetition configuration (block 1520). For example, the network node (e.g., using transmission component 1704 or communication manager 1706, depicted in FIG. 17) may transmit the SIB1 related transmission in the two consecutive based at least in part on the downlink channel repetition configuration, as described above.

Process 1500 may include additional aspects, such as any single aspect or any combination of aspects described below or in connection with one or more other processes described elsewhere herein.

In a first aspect, the PDCCH repetition and PDSCH repetition in the two consecutive slots includes PDSCH content being transmitted with a same RV in both of the two consecutive slots and PDCCH content being replicated in both of the two consecutive slots.

In a second aspect, the PBCH signaling includes a reserved bit that indicates the downlink channel repetition configuration for the SIB1 PDCCH and PDSCH.

In a third aspect, process 1500 includes determining the downlink channel repetition configuration based at least in part on a deployment configuration that includes at least one of a frequency band, a synchronization raster, or a PCI.

In a fourth aspect, the two consecutive slots are configured to be decoded using a non-repetition-based procedure.

Although FIG. 15 shows example blocks of process 1500, in some aspects, process 1500 may include additional blocks, fewer blocks, different blocks, or differently arranged blocks than those depicted in FIG. 15. Additionally, or alternatively, two or more of the blocks of process 1500 may be performed in parallel.

FIG. 16 is a diagram of an example apparatus 1600 for wireless communication. The apparatus 1600 may be a UE, or a UE may include the apparatus 1600. In some aspects, the apparatus 1600 includes a reception component 1602, a transmission component 1604, or a communication manager 1606, which may be in communication with one another (for example, via one or more buses or one or more other components). In some aspects, the communication manager 1606 is the communication manager 150 described in connection with FIG. 1. As shown, the apparatus 1600 may communicate with another apparatus 1608, such as a UE or a network node (such as a CU, a DU, an RU, or a base station), using the reception component 1602 and the transmission component 1604. The communication manager 1606 may be included in, or implemented via, a processing system (for example, the processing system 140 described in connection with FIG. 1) of the UE.

In some aspects, the apparatus 1600 may be configured to perform one or more operations described herein in connection with FIGS. 4-11. Additionally, or alternatively, the apparatus 1600 may be configured to perform one or more processes described herein, such as process 1200 of FIG. 12, or a combination thereof. In some aspects, the apparatus 1600 or one or more components shown in FIG. 16 may include one or more components of the UE described in connection with FIG. 1. Additionally, or alternatively, one or more components shown in FIG. 16 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1602 may receive communications, such as reference signals, control information, data communications, or a combination thereof, from the apparatus 1608. The reception component 1602 may provide received communications to one or more other components of the apparatus 1600. In some aspects, the reception component 1602 may perform signal processing on the received communications, and may provide the processed signals to the one or more other components of the apparatus 1600. In some aspects, the reception component 1602 may include one or more components of the UE described above in connection with FIG. 1, such as a radio, one or more RF chains, one or more transceivers, or one or more modems, each of which may in turn be coupled with one or more antennas of the UE.

The transmission component 1604 may transmit communications, such as reference signals, control information, data communications, or a combination thereof, to the apparatus 1608. In some aspects, one or more other components of the apparatus 1600 may generate communications and may provide the generated communications to the transmission component 1604 for transmission to the apparatus 1608. In some aspects, the transmission component 1604 may perform signal processing on the generated communications, and may transmit the processed signals to the apparatus 1608. In some aspects, the transmission component 1604 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1604 may be co-located with the reception component 1602.

The communication manager 1606 may support operations of the reception component 1602 or the transmission component 1604. For example, the communication manager 1606 may receive information associated with configuring reception of communications by the reception component 1602 or transmission of communications by the transmission component 1604. Additionally, or alternatively, the communication manager 1606 may generate or provide control information to the reception component 1602 or the transmission component 1604 to control reception or transmission of communications.

The reception component 1602 may receive, using a particular deployment configuration, two consecutive slots that are assigned to a SIB1related transmission of a non-terrestrial network. The communication manager 1606 may process at least one slot of the two consecutive slots using a downlink channel repetition configuration that has a linkage or an association to the particular deployment configuration. In some aspects, the communication manager 1606 may decode, based at least in part on the second presence state indicating that the second PDCCH is present, a combined PDSCH.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

FIG. 17 is a diagram of an example apparatus 1700 for wireless communication. The apparatus 1700 may be a network node, or a network node may include the apparatus 1700. In some aspects, the apparatus 1700 includes a reception component 1702, a transmission component 1704, or a communication manager 1706, which may be in communication with one another (for example, via one or more buses or one or more other components). In some aspects, the communication manager 1706 is the communication manager 155 described in connection with FIG. 1. As shown, the apparatus 1700 may communicate with another apparatus 1708, such as a UE or a network node (such as a CU, a DU, an RU, or a base station), using the reception component 1702 and the transmission component 1704. The communication manager 1706 may be included in, or implemented via, a processing system (for example, the processing system 145 described in connection with FIG. 1) of the network node.

In some aspects, the apparatus 1700 may be configured to perform one or more operations described herein in connection with FIGS. 4-11. Additionally, or alternatively, the apparatus 1700 may be configured to perform one or more processes described herein, such as process 1300 of FIG. 13, or a combination thereof. In some aspects, the apparatus 1700 or one or more components shown in FIG. 17 may include one or more components of the network node described in connection with FIG. 1. Additionally, or alternatively, one or more components shown in FIG. 17 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1702 may receive communications, such as reference signals, control information, data communications, or a combination thereof, from the apparatus 1708. The reception component 1702 may provide received communications to one or more other components of the apparatus 1700. In some aspects, the reception component 1702 may perform signal processing on the received communications, and may provide the processed signals to the one or more other components of the apparatus 1700. In some aspects, the reception component 1702 may include one or more components of the network node described above in connection with FIG. 1, such as a radio, one or more RF chains, one or more transceivers, or one or more modems, each of which may in turn be coupled with one or more antennas of the network node. In some aspects, the reception component 1702 or the transmission component 1704 may include or may be included in a network interface. The network interface may be configured to obtain or output signals for the apparatus 1700 via one or more communications links, such as a backhaul link, a midhaul link, or a fronthaul link.

The transmission component 1704 may transmit communications, such as reference signals, control information, data communications, or a combination thereof, to the apparatus 1708. In some aspects, one or more other components of the apparatus 1700 may generate communications and may provide the generated communications to the transmission component 1704 for transmission to the apparatus 1708. In some aspects, the transmission component 1704 may perform signal processing on the generated communications, and may transmit the processed signals to the apparatus 1708. In some aspects, the transmission component 1704 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1704 may be co-located with the reception component 1702.

The communication manager 1706 may support operations of the reception component 1702 or the transmission component 1704. For example, the communication manager 1706 may receive information associated with configuring reception of communications by the reception component 1702 or transmission of communications by the transmission component 1704. Additionally, or alternatively, the communication manager 1706 may generate or provide control information to the reception component 1702 or the transmission component 1704 to control reception or transmission of communications.

The transmission component 1704 may transmit, using a particular deployment configuration, two consecutive slots that are assigned to a system information block type 1 (SIB1) related transmission of a non-terrestrial network, the transmitting being based at least in part on a downlink channel repetition configuration that has a linkage or an association to the particular deployment configuration.

The number and arrangement of components shown in FIG. 17 are provided as an example. In practice, there may be additional components, fewer components, different components, or differently arranged components than those shown in FIG. 17. Furthermore, two or more components shown in FIG. 17 may be implemented within a single component, or a single component shown in FIG. 17 may be implemented as multiple, distributed components. Additionally, or alternatively, a set of (one or more) components shown in FIG. 17 may perform one or more functions described as being performed by another set of components shown in FIG. 17.

The following provides an overview of some Aspects of the present disclosure:

Aspect 1: A method of wireless communication performed by a user equipment (UE), comprising: receiving, using a particular deployment configuration, two consecutive slots that are assigned to a system information block type 1 (SIB1) of a non-terrestrial network; and processing at least one slot of the two consecutive slots using a downlink channel repetition configuration that has a linkage to the particular deployment configuration.

Aspect 2: The method of Aspect 1, wherein the linkage between the downlink channel repetition configuration and the particular deployment configuration is specified by a communication standard.

Aspect 3: The method of any of Aspects 1-2, wherein the linkage between the downlink channel repetition configuration and the particular deployment configuration is based at least in part on a frequency band.

Aspect 4: The method of any of Aspects 1-3, wherein the linkage between the downlink channel repetition configuration and the particular deployment configuration is based at least in part on a synchronization raster.

Aspect 5: The method of any of Aspects 1-4, wherein the linkage between the downlink channel repetition configuration and the particular deployment configuration is based at least in part on a physical cell identifier (PCI).

Aspect 6: The method of any of Aspects 1-5, wherein the linkage between the downlink channel repetition configuration and the particular deployment configuration is not indicated in physical broadcast channel (PBCH) signaling.

Aspect 7: The method of any of Aspects 1-6, wherein the linkage between the downlink channel repetition configuration and the particular deployment configuration is indicated in physical broadcast channel (PBCH) signaling.

Aspect 8: The method of any of Aspects 1-7, wherein the downlink channel repetition configuration comprises a SIB1 physical downlink control channel (PDCCH) and physical downlink shared channel (PDSCH) repetition transmission mode.

Aspect 9: The method of Aspect 8, wherein the SIB1 PDCCH and PDSCH repetition transmission mode comprises at least one of: a mode1 transmission mode that does not include repetition in a second slot of the two consecutive slots, a mode2 transmission mode that does not include repetition in a first slot of the two consecutive slots, a mode3 transmission mode that does not include PDCCH content repetition and includes PDSCH content repetition in the two consecutive slots, or a mode4 transmission mode that includes the PDCCH content repetition and the PDSCH content repetition in the two consecutive slots.

Aspect 10: The method of any of Aspects 1-9, wherein the downlink channel repetition configuration comprises a mode4 transmission mode that includes physical downlink control channel (PDCCH) repetition and physical downlink shared channel (PDSCH) repetition in the two consecutive slots based at least in part on: PDSCH content being transmitted with a same redundancy version (RV) in both of the two consecutive slots and PDCCH content being replicated in both of the two consecutive slots, the PDSCH repetition being transmitted with a first RV in a first slot of the two consecutive slots and a second RV in a second slot of the two consecutive slots, a first PDCCH of the PDCCH repetition indicating the first RV and a second PDCCH of the PDCCH repetition indicating the second RV, or the PDSCH repetition being transmitted with the first RV in the first slot of the two consecutive slots and the second RV in the second slot of the two consecutive slots, the first PDCCH of the PDCCH repetition indicating the first RV and the second PDCCH of the PDCCH repetition indicating the first RV and being scrambled with a different seed than the first PDCCH.

Aspect 11: The method of any of Aspects 1-10, wherein the downlink channel repetition configuration comprises two or more SIB1 physical downlink control channel (PDCCH) and physical downlink shared channel (PDSCH) repetition transmission modes, wherein the two consecutive slots are configured as a particular SIB1 PDCCH and PDSCH repetition transmission mode of the two or more SIB1 PDCCH and PDSCH repetition transmission modes, and wherein the processing comprises: deriving the particular SIB1 PDCCH and PDSCH repetition transmission mode.

Aspect 12: The method of Aspect 11, wherein the two or more SIB1 PDCCH and PDSCH repetition transmission modes comprise a mode1 transmission mode and a mode2 transmission mode, and wherein deriving the particular SIB1 PDCCH and PDSCH repetition transmission mode comprises: deriving the particular SIB1 PDCCH and PDSCH repetition transmission mode using a non-repetition-based procedure.

Aspect 13: The method of Aspect 11, wherein the two or more SIB1 PDCCH and PDSCH repetition transmission modes comprise a mode1 transmission mode, a mode2 transmission mode, and a mode3 transmission mode, and wherein deriving the particular SIB1 PDCCH and PDSCH repetition transmission mode comprises: processing a first slot of the two consecutive slots to detect a presence state of first PDCCH and a decoding state of first PDSCH; and processing, selectively and based at least in part on at least one of the presence state of the first PDCCH and the decoding state of the first PDSCH, a second slot of the two consecutive slots, the processing the second slot comprising: decoding, based at least in part on the presence state indicating a presence of the first PDCCH and the decoding state indicating the first PDSCH is not decoded, a combined PDSCH that is based at least in part on the first PDSCH and a second PDSCH in the second slot of the two consecutive slots; or decoding, based at least in part on the presence state indicating the first PDCCH is not present, a second PDCCH in the second slot and the second PDSCH in the second slot without PDSCH combining.

Aspect 14: The method of Aspect 11, wherein the two or more SIB1 PDCCH and PDSCH repetition transmission modes comprise a mode1 transmission mode and a mode3 transmission mode, and wherein deriving the particular SIB1 PDCCH and PDSCH repetition transmission mode comprises: processing a first slot of the two consecutive slots to detect a presence state of first PDCCH and a decoding state of first PDSCH; and processing, selectively and based at least in part on at least one of the presence state of the first PDCCH and the decoding state of the first PDSCH, a second slot of the two consecutive slots, the processing the second slot comprising: decoding, based at least in part on the presence state indicating a presence of the first PDCCH and the decoding state indicating the first PDSCH is not decoded, a combined PDSCH that is based at least in part on the first PDSCH and a second PDSCH in the second slot of the two consecutive slots; or skipping, based at least in part on the presence state indicating the first PDCCH is not present, decoding of a second PDCCH in the second slot and the second PDSCH in the second slot.

Aspect 15: The method of Aspect 11, wherein the two or more SIB1 PDCCH and PDSCH repetition transmission modes comprise a mode1 transmission mode, a mode2 transmission mode, and a mode4 transmission mode, and wherein deriving the particular SIB1 PDCCH and PDSCH repetition transmission mode comprises: processing a first slot of the two consecutive slots to detect a presence state of first PDCCH and a decoding state of first PDSCH; and processing, selectively and based at least in part on at least one of the presence state of the first PDCCH and the decoding state of the first PDSCH, a second slot of the two consecutive slots, the processing the second slot comprising: decoding, based at least in part on the presence state indicating a presence of the first PDCCH and the decoding state indicating the first PDSCH is not decoded, a combined PDSCH that is based at least in part on the first PDSCH and a second PDSCH in the second slot of the two consecutive slots, decoding, based at least in part on the presence state indicating the first PDCCH is not present and the first PDSCH is not decoded, second PDCCH in the second slot without PDCCH combining, and a second PDSCH in the second slot without PDSCH combining, or decoding, based at least in part on the presence state indicating the first PDCCH is not present and the decoding state indicating the first PDSCH is not decoded, a combined PDCCH, that uses the first PDCCH and the second PDCCH, and the combined PDSCH.

Aspect 16: The method of Aspect 11, wherein the two or more SIB1 PDCCH and PDSCH repetition transmission modes comprise a mode1 transmission mode and a mode4 transmission mode, and wherein deriving the particular SIB1 PDCCH and PDSCH repetition transmission mode comprises: processing a first slot of the two consecutive slots to detect a first presence state of first PDCCH in the first slot and a decoding state of first PDSCH in the first slot; and processing, selectively and based at least in part on at least one of the first presence state of the first PDCCH and the decoding state of the first PDSCH, a second slot of the two consecutive slots, the processing the second slot comprising: decoding, based at least in part on the first presence state indicating a presence of the first PDCCH and the decoding state indicating the first PDSCH is not decoded, a combined PDSCH that is based at least in part on the first PDSCH and a second PDSCH in the second slot of the two consecutive slots, or decoding, based at least in part on the presence state indicating the first PDCCH is not present, a combined PDCCH that is based at least in part on the first PDCCH and second PDCCH in the second slot, and, based at least in part on successful decoding of the combined PDCCH, the combined PDSCH.

Aspect 17: The method of any of Aspects 1-16, wherein processing at least the one slot of the two consecutive slots comprises: performing physical downlink control channel (PDCCH) combining based at least in part on an expectation that a PDCCH payload of a first PDCCH in a first slot of the two consecutive slots is duplicated in a second PDCCH in a second slot of the two consecutive slots.

Aspect 18: The method of any of Aspects 1-17, wherein processing at least the one slot of the two consecutive slots comprises: performing physical downlink shared channel (PDSCH) decoding of a first PDSCH in a first slot of the two consecutive slots using a first redundancy version (RV) indicated by first physical downlink control channel (PDCCH) in the first slot; and performing PDSCH decoding of a second PDSCH in a second slot of the two consecutive slots based at least in part on an expectation that the second PDSCH uses the first RV.

Aspect 19: The method of any of Aspects 1-18, wherein processing at least the one slot of the two consecutive slots comprises: decoding first physical downlink control channel (PDCCH) in a first slot of the two consecutive slots using a first redundancy version (RV); and decoding second PDCCH in a second slot of the two consecutive slots using a second RV that is different from the first RV.

Aspect 20: The method of any of Aspects 1-19, wherein processing at least the one slot of the two consecutive slots comprises: performing physical downlink shared channel (PDSCH) decoding of a first PDSCH in a first slot of the two consecutive slots using a first redundancy version (RV) indicated by first physical downlink control channel (PDCCH) in the first slot; and performing PDSCH decoding of a second PDSCH in a second slot of the two consecutive slots based at least in part using a second RV indicated by second PDCCH in the second slot.

Aspect 21: The method of any of Aspects 1-20, wherein processing at least the one slot of the two consecutive slots comprises: decoding first physical downlink control channel (PDCCH) in a first slot of the two consecutive slots based at least in part on a first scrambling seed, the first PDCCH indicating a redundancy version (RV); and decoding second PDCCH in a second slot of the two consecutive slots based at least in part on a second scrambling seed that is different from the first scrambling seed, the second PDCCH indicating the RV indicated by the first PDCCH.

Aspect 22: The method of any of Aspects 1-21, wherein processing at least the one slot of the two consecutive slots comprises: decoding second physical downlink control channel (PDCCH) in a second slot of the two consecutive slots with an expectation that the second PDCCH indicates a redundancy version (RV) for decoding physical downlink shared channel (PDSCH) in a first slot of the two consecutive slots.

Aspect 23: A method of wireless communication performed by a network node, comprising: transmitting, using a particular deployment configuration, two consecutive slots that are assigned to a system information block type 1 (SIB1) of a non-terrestrial network, the transmitting being based at least in part on a downlink channel repetition configuration that has a linkage to the particular deployment configuration.

Aspect 24: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-22.

Aspect 25: An apparatus for wireless communication at a device, the apparatus comprising one or more memories and one or more processors coupled to the one or more memories, the one or more processors configured to cause the device to perform the method of one or more of Aspects 1-22.

Aspect 26: An apparatus for wireless communication, the apparatus comprising at least one means for performing the method of one or more of Aspects 1-22.

Aspect 27: A non-transitory computer-readable medium storing code for wireless communication, the code comprising instructions executable by one or more processors to perform the method of one or more of Aspects 1-2.

Aspect 28: A non-transitory computer-readable medium storing a set of instructions for wireless communication, the set of instructions comprising one or more instructions that, when executed by one or more processors of a device, cause the device to perform the method of one or more of Aspects 1-22.

Aspect 29: A device for wireless communication, the device comprising a processing system that includes one or more processors and one or more memories coupled with the one or more processors, the processing system configured to cause the device to perform the method of one or more of Aspects 1-22.

Aspect 30: An apparatus for wireless communication at a device, the apparatus comprising one or more memories and one or more processors coupled to the one or more memories, the one or more processors individually or collectively configured to cause the device to perform the method of one or more of Aspects 1-22.

Aspect 31: A device comprising a processing system that includes one or more processors and one or more code-storing memories coupled with the one or more processors, the processing system configured to cause the device to perform the method of one or more of Aspects 1-22.

Aspect 32: A device comprising a processing system that includes processor circuitry and code-storing memory circuitry, the processing system configured to cause the device to perform the method of one or more of Aspects 1-22.

Aspect 33: An apparatus for wireless communication at a device, the apparatus comprising one or more processors; one or more memories coupled with the one or more processors; and instructions stored in the one or more memories and executable by the one or more processors to cause the apparatus to perform the method of Aspect 23.

Aspect 34: An apparatus for wireless communication at a device, the apparatus comprising one or more memories and one or more processors coupled to the one or more memories, the one or more processors configured to cause the device to perform the method of Aspect 23.

Aspect 35: An apparatus for wireless communication, the apparatus comprising at least one means for performing the method of Aspect 23.

Aspect 36: A non-transitory computer-readable medium storing code for wireless communication, the code comprising instructions executable by one or more processors to perform the method of Aspect 23.

Aspect 37: A non-transitory computer-readable medium storing a set of instructions for wireless communication, the set of instructions comprising one or more instructions that, when executed by one or more processors of a device, cause the device to perform the method of Aspect 23.

Aspect 38: A device for wireless communication, the device comprising a processing system that includes one or more processors and one or more memories coupled with the one or more processors, the processing system configured to cause the device to perform the method of Aspect 23.

Aspect 39: An apparatus for wireless communication at a device, the apparatus comprising one or more memories and one or more processors coupled to the one or more memories, the one or more processors individually or collectively configured to cause the device to perform the method of Aspect 23.

Aspect 40: A device comprising a processing system that includes one or more processors and one or more code-storing memories coupled with the one or more processors, the processing system configured to cause the device to perform the method of Aspect 23.

Aspect 41: A device comprising a processing system that includes processor circuitry and code-storing memory circuitry, the processing system configured to cause the device to perform the method of Aspect 23.

Aspect 42: A method of wireless communication performed by a user equipment (UE), comprising: receiving physical broadcast channel (PBCH) signaling that indicates a downlink channel repetition configuration for a system information block type 1 (SIB1) physical downlink control channel (PDCCH) and physical downlink shared channel (PDSCH), the downlink channel repetition configuration including PDCCH content repetition and PDSCH content repetition in two consecutive slots that are assigned to a SIB1 related transmission; receiving the SIB1 related transmission in two consecutive slots that are assigned to the SIB1 related transmission and include the PDCCH content repetition and the PDSCH content repetition; and processing at least one slot of the two consecutive slots using the downlink channel repetition configuration.

Aspect 43: A method of wireless communication performed by a network node, comprising: transmitting physical broadcast channel (PBCH) signaling that indicates a downlink channel repetition configuration for a system information block type 1 (SIB1) physical downlink control channel (PDCCH) and physical downlink shared channel (PDSCH), the downlink channel repetition configuration including PDCCH content repetition and PDSCH content repetition in two consecutive slots that are assigned to a SIB1 related transmission; and transmitting the SIB1 related transmission in the two consecutive based at least in part on the downlink channel repetition configuration.

Aspect 44: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 41 or 42.

Aspect 45: An apparatus for wireless communication, the apparatus comprising at least one means for performing the method of one or more of Aspects 41 or 42.

Aspect 46: A non-transitory computer-readable medium storing code for wireless communication, the code comprising instructions executable by one or more processors to perform the method of one or more of Aspects 41 or 42.

Aspect 47: A non-transitory computer-readable medium storing a set of instructions for wireless communication, the set of instructions comprising one or more instructions that, when executed by one or more processors of a device, cause the device to perform the method of one or more of Aspects 41 or 42.

Aspect 48: A device for wireless communication, the device comprising a processing system that includes one or more processors and one or more memories coupled with the one or more processors, the processing system configured to cause the device to perform the method of one or more of Aspects 41 or 42.

Aspect 49: An apparatus for wireless communication at a device, the apparatus comprising one or more memories and one or more processors coupled to the one or more memories, the one or more processors individually or collectively configured to cause the device to perform the method of one or more of Aspects 41 or 42.

Aspect 50: A device comprising one or more antennas, and a processing system that includes one or more processors and one or more memories that store code and are coupled with the one or more processors, the processing system configured to cause the device to perform the method of one or more of Aspects 41 or 42.

Aspect 51: A device comprising one or more antennas, and a processing system that includes processor circuitry and memory circuitry that stores code, the processing system configured to cause the device to perform the method of one or more of Aspects 41 or 42.

Further disclosure is included in the appendix. The appendix is provided as an example only and is to be considered part of the specification. A definition, illustration, or other description in the appendix does not supersede or override similar information included in the detailed description or figures. Furthermore, a definition, illustration, or other description in the detailed description or figures does not supersede or override similar information included in the appendix. Furthermore, the appendix is not intended to limit the disclosure of possible aspects.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes processor circuitry and code-storing memory circuitry, the processing system configured to cause the UE to:
receive physical broadcast channel (PBCH) signaling that indicates a downlink channel repetition configuration for a system information block type 1 (SIB1) physical downlink control channel (PDCCH) and physical downlink shared channel (PDSCH), the downlink channel repetition configuration comprising PDCCH content repetition and PDSCH content repetition in two consecutive slots that are assigned to a SIB1 related transmission;
receive the SIB1 related transmission in the two consecutive slots that are assigned to the SIB1 related transmission and include the PDCCH content repetition and the PDSCH content repetition; and
process at least one slot of the two consecutive slots using the downlink channel repetition configuration.

2. The UE of claim 1, wherein the PDCCH content repetition and the PDSCH content repetition in the two consecutive slots comprises PDSCH content being transmitted with a same redundancy version (RV) in both of the two consecutive slots and PDCCH content being replicated in both of the two consecutive slots.

3. The UE of claim 1, wherein the processing system, to cause the UE to process at least the one slot of the two consecutive slots, is configured to cause the UE to:
perform PDCCH combining based at least in part on an expectation that a PDCCH payload of a first PDCCH in a first slot of the two consecutive slots is duplicated in a second PDCCH in a second slot of the two consecutive slots.

4. The UE of claim 1, wherein the processing system, to cause the UE to process at least the one slot of the two consecutive slots, is configured to cause the UE to:
perform PDSCH decoding of a first PDSCH in a first slot of the two consecutive slots using a first redundancy version (RV) indicated by first PDCCH in the first slot; and
perform PDSCH decoding of a second PDSCH in a second slot of the two consecutive slots based at least in part on an expectation that the second PDSCH uses the first RV.

5. The UE of claim 1, wherein the PBCH signaling includes a reserved bit that indicates an enabled state or disabled state for SIB1 PDCCH and SIB1 PDSCH repetition.

6. The UE of claim 5, wherein the reserved bit indicates an enabled state for the SIB1 PDCCH and PDSCH repetition.

7. The UE of claim 1, wherein the processing system is configured to cause the UE to :
selectively perform PDCCH combining or PDSCH combining based at least in part on a determination of at least one of:
unsuccessful detection in a first slot of the two consecutive slots, or
unsuccessful decoding in the first slot of the two consecutive slots.

8. The UE of claim 1, wherein the processing system is configured to cause the UE to:
determine the downlink channel repetition configuration based at least in part on a deployment configuration that includes at least one of:
a frequency band,
a synchronization raster, or
a physical cell identifier (PCI).

9. The UE of claim 1, wherein the two consecutive slots are configured to be decoded using a non-repetition-based procedure.

10. The UE of claim 1, wherein the processing system is configured to cause the UE to:
buffer a first PDSCH from a first slot of the two consecutive slots and a second PDSCH from a second slot of the two consecutive slots; and
decode the SIB1 related transmission using a PDSCH combining procedure.

11. The UE of claim 1, wherein the processing system is configured to cause the UE to:
buffer a first PDCCH from a first slot of the two consecutive slots and a second PDCCH from a second slot of the two consecutive slots; and
decode the first PDCCH and the second PDCCH using a PDCCH combining procedure.

12. A network node, comprising:
a processing system that includes processor circuitry and code-storing memory circuitry, the processing system configured to cause the network node to:
transmit physical broadcast channel (PBCH) signaling that indicates a downlink channel repetition configuration for a system information block type 1 (SIB1) physical downlink control channel (PDCCH) and physical downlink shared channel (PDSCH), the downlink channel repetition configuration including PDCCH content repetition and PDSCH content repetition in two consecutive slots that are assigned to a SIB1 related transmission; and
transmit the SIB1 related transmission in the two consecutive slots, the processing system configured to cause the network node to transmit the SIB1 related transmission based at least in part on the downlink channel repetition configuration.

13. The network node of claim 12, wherein the PDCCH repetition and PDSCH repetition in the two consecutive slots comprises PDSCH content being transmitted with a same redundancy version (RV) in both of the two consecutive slots and PDCCH content being replicated in both of the two consecutive slots.

14. The network node of claim 12, wherein the PBCH signaling includes a reserved bit that indicates the downlink channel repetition configuration for the SIB1 PDCCH and PDSCH.

15. The network node of claim 14, wherein the reserved bit indicates an enabled state for the SIB1 PDCCH and PDSCH repetition.

16. The network node of claim 12, wherein the processing system is configured to cause the network node to determine the downlink channel repetition configuration based at least in part on a deployment configuration that includes at least one of:
a frequency band,
a synchronization raster, or
a physical cell identifier (PCI).

17. The network node of claim 12, wherein the two consecutive slots are configured to be decoded using a non-repetition-based procedure.

18. A method of wireless communication performed by a user equipment (UE), comprising:
receiving physical broadcast channel (PBCH) signaling that indicates a downlink channel repetition configuration for a system information block type 1 (SIB1) physical downlink control channel (PDCCH) and physical downlink shared channel (PDSCH), the downlink channel repetition configuration including PDCCH content repetition and PDSCH content repetition in two consecutive slots that are assigned to a SIB1 related transmission;
receiving the SIB1 related transmission in two consecutive slots that are assigned to the SIB1 related transmission and include the PDCCH content repetition and the PDSCH content repetition; and
processing at least one slot of the two consecutive slots using the downlink channel repetition configuration.

19. The method of claim 18, wherein the PDCCH repetition and PDSCH repetition in the two consecutive slots comprises PDSCH content being transmitted with a same redundancy version (RV) in both of the two consecutive slots and PDCCH content being replicated in both of the two consecutive slots.

20. The method of claim 18, further comprising:
performing PDCCH combining based at least in part on an expectation that a PDCCH payload of a first PDCCH in a first slot of the two consecutive slots is duplicated in a second PDCCH in a second slot of the two consecutive slots.

21. The method of claim 18, further comprising:
performing PDSCH decoding of a first PDSCH in a first slot of the two consecutive slots using a first redundancy version (RV) indicated by first PDCCH in a first slot of the two consecutive slots; and
performing PDSCH decoding of a second PDSCH in a second slot of the two consecutive slots based at least in part on an expectation that the second PDSCH uses the first RV.

22. The method of claim 18, wherein the PBCH signaling includes a reserved bit that indicates the downlink channel repetition configuration for the SIB1 PDCCH and PDSCH.

23. The method of claim 22, wherein the reserved bit indicates an enabled state for the SIB1 PDCCH and PDSCH repetition.

24. The method of claim 18 further comprising:
selectively performing PDCCH combining or PDSCH combining based at least in part on a determination of unsuccessful decoding in a first slot of the two consecutive slots.

25. The method of claim 18, further comprising:
determining the downlink channel repetition configuration based at least in part on a deployment configuration that includes at least one of: a frequency band, a synchronization raster, or a physical cell identifier (PCI).

26. A method of wireless communication performed by a network node, comprising:
transmitting physical broadcast channel (PBCH) signaling that indicates a downlink channel repetition configuration for a system information block type 1 (SIB1) physical downlink control channel (PDCCH) and physical downlink shared channel (PDSCH), the downlink channel repetition configuration including PDCCH content repetition and PDSCH content repetition in two consecutive slots that are assigned to a SIB1 related transmission; and
transmitting the SIB1 related transmission in the two consecutive based at least in part on the downlink channel repetition configuration.

27. The method of claim 26, wherein the PDCCH repetition and PDSCH repetition in the two consecutive slots comprises PDSCH content being transmitted with a same redundancy version (RV) in both of the two consecutive slots and PDCCH content being replicated in both of the two consecutive slots.

28. The method of claim 26, wherein the PBCH signaling includes a reserved bit that indicates the downlink channel repetition configuration for the SIB1 PDCCH and PDSCH.

29. The method of claim 26, further comprising:
determining the downlink channel repetition configuration based at least in part on a deployment configuration that includes at least one of: a frequency band, a synchronization raster, or a physical cell identifier (PCI).

30. The method of claim 26, wherein the two consecutive slots are configured to be decoded using a non-repetition-based procedure.
